(19) United States
(12) Patent Application Publication
(10) Pub. No.: US 2006/0145853 A1
(43) Pub. Date: Jul. 6, 2006

(54) System and method for detecting objects and communicating information

(75) Inventors: James L. Richards, Fayetteville, TN (US); Larry W. Fullerton, Owens Crossroads, AL (US); Ivan A. Cowie, Madison, AL (US)

Correspondence Address: JAMES RICHARDS, 58 BONING RD, FAYETTEVILLE, TN, 37334, US

(73) Assignee: Time Domain Corporation, Huntsville, AL (US)

(21) Appl. No.: 11/021,753

(22) Filed: Dec. 22, 2004

(51) Int. Cl. G08B 13/14; H04Q 5/22

(52) U.S. Cl. 340/572.1; 340/10.1

(57) ABSTRACT

A system and method for locating objects and/or receiving data associated with an object. An antenna or similar device that can intercept or modify RF energy is caused to vary its properties in accordance with a predefined time sequence pattern that is associated with the object. The antenna device is located proximate to the object to be located. To locate the object, a wide band radar device is utilized to transmit a probe signal and receive and analyze the return signal to identify the predefined pattern and determine the range to the antenna and thus determine the range to the associated object. The time sequence pattern is optionally modulated by a data stream to convey data associated with the object.

### BACKGROUND OF THE INVENTION

1. Field of the invention

The present invention relates to the field of radio locating tags, in particular, non-transmitting locating tags.

2. Related applications

This application incorporates by reference Provisional Application 60/323,560 titled “UWB Reflective Tag System and Method,” filed Sep. 20, 2001.

3. Related Art

RF tags for detecting and relaying information about an object have found wide application in industry and commerce. Applications for tags range from simply detecting the proximate presence of an object to relaying information, such as for personnel security access control or toll booth charging systems.

One system in use transmits an RF microwave field strong enough to be directly rectified to supply power to a transmitter chip which in turn transmits information, such as a serial number, which is then received by the probing system. The serial number then, is used for tollbooth billing, or security access or other purpose as needed by the application. This system, however, utilizes a very strong RF probing field that requires very high gain antennas to be projected to significant distances, consumes considerable power at the transmitter, and cannot easily resolve fine distances or distinguish multiple tags simultaneously in the field.

Another system is used in the personnel security access business. This system utilizes a frequency of 300 kHz and couples to a tag using inductive coupling. Again the excitation energy is used to power a chip. The chip then couples a signal back through the inductive coupling arrangement. The signal may convey information comprising a serial number, which is used to enable or deny access. The inductive coupling system is typically limited to a range of a few inches.

A further system utilizes an active tag that transmits periodically conveying a serial number or other information. This system, however, requires a significant battery to supply the transmitted RF power. The power requirement is mitigated by operating on a short duty cycle.

Each of these technologies has one or more requirements that limit its use in certain applications. Thus, there exists a need for improved methods and systems for detecting and locating objects and communicating information from the objects.

### BRIEF SUMMARY OF THE INVENTION

The present invention is a system and method for locating objects and/or receiving data associated with an object. In brief, an antenna or similar device that can intercept or modify RF energy is caused to vary its properties in accordance with a predefined time sequence pattern that is associated with the object. The antenna device is located proximate to the object to be located. To locate the object, a wide band radar device is utilized to transmit a probe signal and receive and analyze the return signal to identify the predefined time sequence pattern and determine the range to the antenna and thus determine the range to the associated object.

The antenna device together with a modulator and controller is called a reflective tag. The reflective tag may be associated with a person or object by locating the tag with the person or object. The reflective tag operates by detecting modulation of the impedance of the tag antenna. The modulation may be low frequency modulation possibly in the audio range. The modulation is synchronously detected in the radar by operating a synchronous detector at the same frequency and pattern as the one in the reflective tag controller.

One advantage of the present invention is that the antenna and property varying components can be made very small, light weight, low cost and can be constructed so as to consume very little battery power, thus enabling operation for months or years on practical batteries, achieving operational lifetimes similar to battery operated watches and clocks.

Another advantage of the present invention is that the radar system can separate and select antennas utilizing relative return signal delay resulting from differences in range and thus accommodate multiple objects with reduced interference from non-selected objects. The multiple objects may even utilize a single pattern or family of patterns. The total capacity, or number of antenna devices that can be operated in a given area can be multiplied by this resolution factor.

A further advantage of the present invention is that multipath reflections do not cancel in the manner of narrow band Rayleigh fading so that it is relatively difficult to place an antenna in a location or configuration where it cannot be detected due to Rayleigh fading.

A further advantage of the present invention is that the distance to the antenna device can be determined very accurately, for example, to on the order of a wavelength of the nominal bandwidth of the probing radar. This may be one foot (30 cm) or so for a typical UWB radar with a 1 GHz bandwidth.

A further advantage is that the frequency or rate of change of the pattern is not critical, permitting very low cost reference oscillators and enabling low cost antenna devices.

A further advantage is that data may be encoded on the pattern to enable communication of such information as a serial number, a temperature measurement, an audio signal, external data, or accounting information as in a frequent shopper card, or personnel access information as in an entry identification tag, or other information as needed for the many potential uses for this invention.

These advantages are provided by the invention through one or more of the embodiments. In one embodiment of the invention, the reflective properties of an antenna are modulated by a switch device coupled to the feed point of the antenna wherein the switch device switches between an impedance relatively higher than the characteristic impedance of the antenna, ideally an open circuit, to an impedance relatively lower than the characteristic impedance of the antenna, ideally a short circuit.

In one embodiment of the invention, the reflective properties of an antenna are modulated by a switch device coupled to the feed point of the antenna wherein the switch device switches between or among at least two different complex impedance states.

In further embodiments of the invention, the switch device may utilize at least one of a bipolar transistor, a field effect transistor, a diode, a PIN diode, a MEMS device, a mechanical switch, a varactor diode, and a variable inductor.

In one embodiment of the invention, the switching pattern is a predetermined frequency. A radar receiver configured to locate the device in accordance with one embodiment of the invention utilizes a fast Fourier transform (FFT) algorithm to identify the predetermined frequency signal.

In an alternative embodiment, the switching pattern is a predetermined time code sequence. A radar receiver configured to locate this device in accordance with the alternative embodiment of the invention utilizes a time shift correlation algorithm to identify the predetermined code signal.

In a further embodiment, the tag and probing radar utilize cross polarization to identify the tag.

In a further embodiment, the tag utilizes reflections from multiple delays to generate pulse position modulation on the reflected signal.

In a further embodiment, the tag and probing device operate using a narrow band probing signal to identify the tag and a UWB probing signal to locate the tag. The narrow band probing device may provide timing and/or velocity information to the UWB probing device to allow faster acquisition of the tag signal.

In a further embodiment, the modulated reflected signal from a first object is distinguished from the modulated reflected signal from a second object by range gating the modulated reflected signal from the first object.

### BRIEF DESCRIPTION OF THE DRAWINGS

The present invention is described with reference to the accompanying drawings. In the drawings, like reference numbers indicate identical or functionally similar elements. Additionally, the left most digit(s) of a reference number identifies the drawing in which the reference number first appears.

FIG. 1A illustrates a representative Gaussian Monocycle waveform in the time domain;

FIG. 1B illustrates the frequency domain amplitude of the Gaussian Monocycle of FIG. 1A;

FIG. 1C represents the second derivative of a Gaussian pulse;

FIG. 1D represents the third derivative of the Gaussian pulse;

FIG. 1E represents the Correlator Output vs. the Relative Delay of a measured pulse signal;

FIG. 1F depicts the frequency domain amplitude of the Gaussian family of the Gaussian Pulse and the first, second, and third derivative;

FIG. 2A illustrates a pulse train comprising pulses as in FIG. 1A;

FIG. 2B illustrates the frequency domain amplitude of the waveform of FIG. 2A;

FIG. 2C illustrates the pulse train spectrum;

FIG. 2D is a plot of the Frequency vs. Energy;

FIG. 3 illustrates the cross-correlation of two codes graphically as Coincidences vs. Time Offset;

FIGS. 4A-4E illustrate five modulation techniques to include: Early-Late Modulation, One of Many Modulation, Flip Modulation, Quad Flip Modulation, and Vector Modulation;

FIG. 5A illustrates representative signals of an interfering signal, a coded received pulse train and a coded reference pulse train;

FIG. 5B depicts a typical geometrical configuration giving rise to multipath received signals;

FIG. 5C illustrates exemplary multipath signals in the time domain;

FIGS. 5D-5F illustrate a signal plot of various multipath environments;

FIG. 5G illustrates the Rayleigh fading curve associated with non-impulse radio transmissions in a multipath environment;

FIG. 5H illustrates a plurality of multipaths with a plurality of reflectors from a transmitter to a receiver;

FIG. 5I graphically represents signal strength as volts vs. time in a direct path and multipath environment;

FIG. 6 illustrates a representative impulse radio transmitter functional diagram;

FIG. 7 illustrates a representative impulse radio receiver functional diagram;

FIG. 8A illustrates a representative received pulse signal at the input to the correlator;

FIG. 8B illustrates a sequence of representative impulse signals in the correlation process;

FIG. 8C illustrates the output of the correlator for each of the time offsets of FIG. 8B;

FIG. 9 is an idealized illustration of the basic elements of the preferred embodiment of the present invention;

FIG. 10 is a depiction of two representative return signal waveforms in the radar receiver;

FIG. 11 depicts a typical radar reflection scan of a cluttered environment that includes a reflective tag;

FIG. 12 depicts an exemplary magnitude plot of radar reflection scan of a cluttered environment that includes a reflective tag;

FIG. 13 illustrates a basic system utilizing a code and optionally conveying data associated with the object;

FIG. 14 is a simplified diagram of an exemplary radar in accordance with the present invention;

FIG. 15 illustrates an exemplary code matching process utilizing a single correlator;

FIG. 16 is a block diagram of an I/Q code matching process;

FIG. 17 illustrates an exemplary embodiment of an alternative code matching function in accordance with the present invention;

FIG. 18 illustrates a tag system based on frequency modulation;

FIG. 19 illustrates an exemplary radar probing system adapted to detect a tag wherein the tag is frequency modulated;

FIG. 20 is a schematic diagram of a reflective tag utilizing a FET switch element;

FIG. 21 is a schematic diagram of a reflective tag utilizing a bipolar transistor as a switch element;

FIG. 22 depicts a reflective tag utilizing a PIN diode as a switch element;

FIG. 23 illustrates one embodiment employing a varactor diode as a switch element;

FIG. 24 illustrates an alternative embodiment employing varactor diodes as switch elements;

FIG. 25 illustrates a further alternative embodiment employing varactor diodes;

FIG. 26 represents a system based on using a saturable reactor as a switch element;

FIG. 27 represents a system based on a variable capacitance element;

FIG. 28 represents a system based on a MEMS switch;

FIG. 29 illustrates a reflective tag utilizing cross polarization;

FIG. 30 illustrates a dual mode tag system in accordance with the present invention; and

FIG. 31 illustrates a variable delay tag.

### DETAILED DESCRIPTION OF THE INVENTION

Further features and advantages of the invention will become apparent in the following detailed description of the invention and its various embodiments. The first section is a brief overview of Ultra Wideband technology to help in the understanding of the present invention. Numerous features or embodiments of the present invention incorporate or depend on the Ultra Wideband technology described.

Ultra Wideband Technology Overview

Ultra Wideband is an emerging RF technology with significant benefits in communications, radar, positioning and sensing applications. In 2002, the Federal Communications Commission (FCC) recognized these potential benefits to the consumer and issued the first rulemaking enabling the commercial sale and use of products based on Ultra Wideband technology in the United States of America. The FCC adopted a definition of Ultra Wideband to be a signal that occupies a fractional bandwidth of at least 0.25, or 500 MHz bandwidth at any center frequency. The 0.25 fractional bandwidth is more precisely defined as:

$$FBW = \frac{2 ( {f}_{h} - {f}_{l} )}{{f}_{h} + {f}_{l}} ,$$

where FBW is the fractional bandwidth, fₕ is the upper band edge and fₗ is the lower band edge, the band edges being defined as the 10 dB down point in spectral density.

There are many approaches to UWB including impulse radio, direct sequence CDMA, ultra wideband noise radio, direct modulation of ultra high-speed data, and other methods. The present invention has its origin in ultra wideband impulse radio and will have significant application there as well, but it has potential benefit and application beyond impulse radio to other forms of ultra wideband and beyond ultra wideband to conventional radio systems as well. Nonetheless, it is useful to describe the invention in relation to impulse radio to understand the basics and then expand the description to the extensions of the technology.

The following is an overview of impulse radio as an aid in understanding the benefits of the present invention.

Impulse radio has been described in a series of patents, including U.S. Pat. No. 4,641,317 (issued Feb. 3, 1987), U.S. Pat. No. 4,813,057 (issued Mar. 14, 1989), U.S. Pat. No. 4,979,186 (issued Dec. 18, 1990), and U.S. Pat. No. 5,363,108 (issued Nov. 8, 1994) to Larry W. Fullerton. A second generation of impulse radio patents includes U.S. Pat. No. 5,677,927 (issued Oct. 14, 1997), U.S. Pat. No. 5,687,169 (issued Nov. 11, 1997), U.S. Pat. No. 5,764,696 (issued Jun. 9, 1998), U.S. Pat. No. 5,832,035 (issued Nov. 3, 1998), and U.S. Pat. No. 5,969,663 (issued Oct. 19, 1999) to Fullerton et al, and U.S. Pat. No. 5,812,081 (issued Sep. 22, 1998), and U.S. Pat. No. 5,952,956 (issued Sep. 14, 1999) to Fullerton, which are incorporated herein by reference.

Uses of impulse radio systems are described in U.S. Pat. No. 6,177,903 (issued Jan. 23, 2001) titled, “System and Method for Intrusion Detection using a Time Domain Radar Array”, U.S. Pat. No. 6,218,979 (issued Apr. 17, 2001) titled “Wide Area Time Domain Radar Array”, and U.S. Pat. No. 6,614,384 (issued Sep. 2, 2003) titled “System and Method for Detecting an Intruder Using Impulse Radio Technology”, all of which are incorporated herein by reference.

Acquisition approaches involving acquisition thresholds are described in U.S. Pat. No. 5,832,035, titled “Fast Locking Mechanism for Channelized Ultrawide-Band Communications,” issued Nov. 3, 1998 to Fullerton, which was incorporated by reference above, and in U.S. Pat. No. 6,556,621, titled “System and Method for Fast Acquisition of Ultra Wideband Signals,” issued Apr. 29, 2003 to Richards et al., which is incorporated herein by reference.

This section provides an overview of impulse radio technology and relevant aspects of communications theory. It is provided to assist the reader with understanding the present invention and should not be used to limit the scope of the present invention. It should be understood that the terminology ‘impulse radio’ is used primarily for historical convenience and that the terminology can be generally interchanged with the terminology ‘impulse communications system, ultra-wideband system, or ultra-wideband communication systems’. Furthermore, it should be understood that the described impulse radio technology is generally applicable to various other impulse system applications including but not limited to impulse radar systems and impulse positioning systems. Accordingly, the terminology ‘impulse radio’ can be generally interchanged with the terminology ‘impulse transmission system and impulse reception system.’

Impulse radio refers to a radio system based on short, wide bandwidth pulses. An ideal impulse radio waveform is a short Gaussian monocycle. As the name suggests, this waveform attempts to approach one cycle of radio frequency (RF) energy at a desired center frequency. Due to implementation and other spectral limitations, this waveform may be altered significantly in practice for a given application. Many waveforms having very broad, or wide, spectral bandwidth approximate a Gaussian shape to a useful degree.

Impulse radio can use many types of modulation, including amplitude modulation, phase modulation, frequency modulation (including frequency shape and wave shape modulation), time-shift modulation (also referred to as pulse-position modulation or pulse-interval modulation) and M-ary versions of these. In this document, the time-shift modulation method is often used as an illustrative example. However, someone skilled in the art will recognize that alternative modulation approaches may, in some instances, be used instead of or in combination with the time-shift modulation approach.

In impulse radio communications, inter-pulse spacing may be held constant or may be varied on a pulse-by-pulse basis by information, a code, or both. Generally, conventional spread spectrum systems employ codes to spread the normally narrow band information signal over a relatively wide band of frequencies. A conventional spread spectrum receiver correlates these signals to retrieve the original information signal. In impulse radio communications, codes are not typically used for energy spreading because the monocycle pulses themselves have an inherently wide bandwidth. Codes are more commonly used for channelization, energy smoothing in the frequency domain, resistance to interference, and reducing the interference potential to nearby receivers. Such codes are commonly referred to as time-hopping codes or pseudo-noise (PN) codes since their use typically causes inter-pulse spacing to have a seemingly random nature. PN codes may be generated by techniques other than pseudorandom code generation. Additionally, pulse trains having constant, or uniform, pulse spacing are commonly referred to as uncoded pulse trains. A pulse train with uniform pulse spacing, however, may be described by a code that specifies non-temporal, i.e., non-time related, pulse characteristics.

In impulse radio communications utilizing time-shift modulation, information comprising one or more bits of data typically time-position modulates a sequence of pulses. This yields a modulated, coded timing signal that comprises a train of pulses from which a typical impulse radio receiver employing the same code may demodulate and, if necessary, coherently integrate pulses to recover the transmitted information.

The impulse radio receiver is typically a direct conversion receiver with a cross correlator front-end that coherently converts an electromagnetic pulse train of monocycle pulses to a baseband signal in a single stage. The baseband signal is the basic information signal for the impulse radio communications system. A subcarrier may also be included with the baseband signal to reduce the effects of amplifier drift and low frequency noise. Typically, the subcarrier alternately reverses modulation according to a known pattern at a rate faster than the data rate. This same pattern is used to reverse the process and restore the original data pattern just before detection. This method permits alternating current (AC) coupling of stages, or equivalent signal processing, to eliminate direct current (DC) drift and errors from the detection process. This method is described in more detail in U.S. Pat. No. 5,677,927 to Fullerton et al.

Waveforms

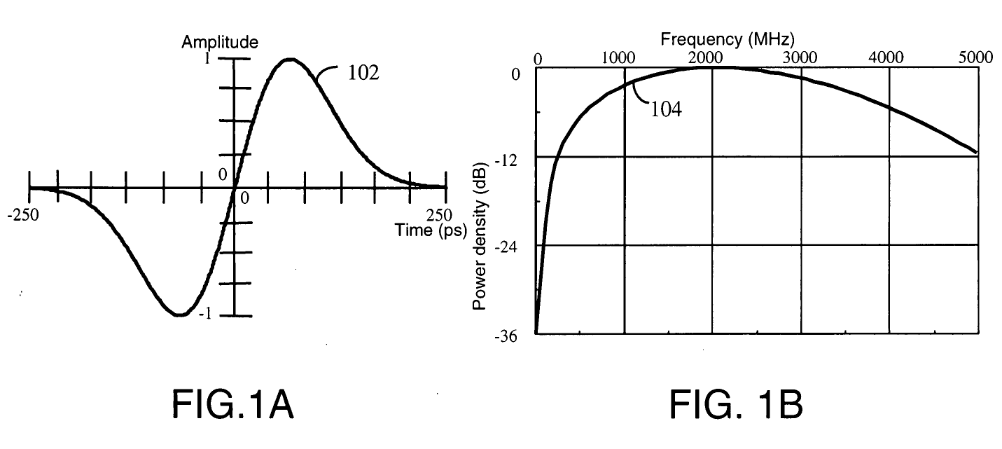

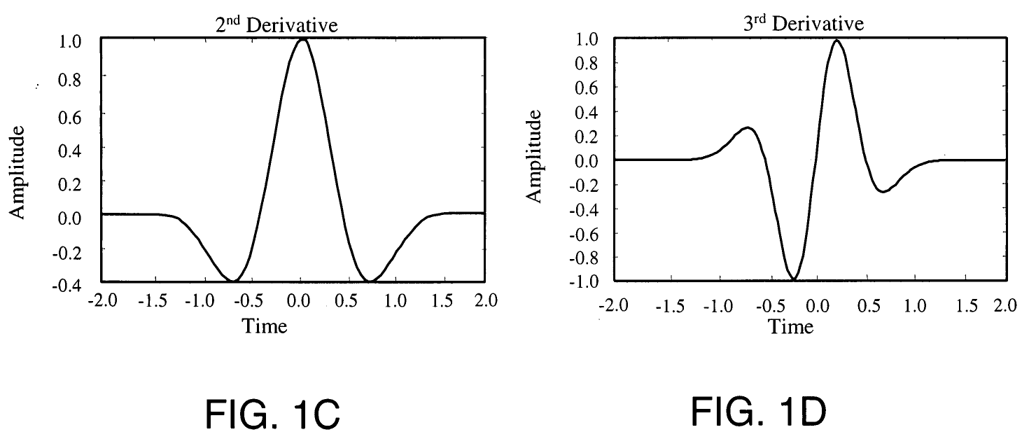

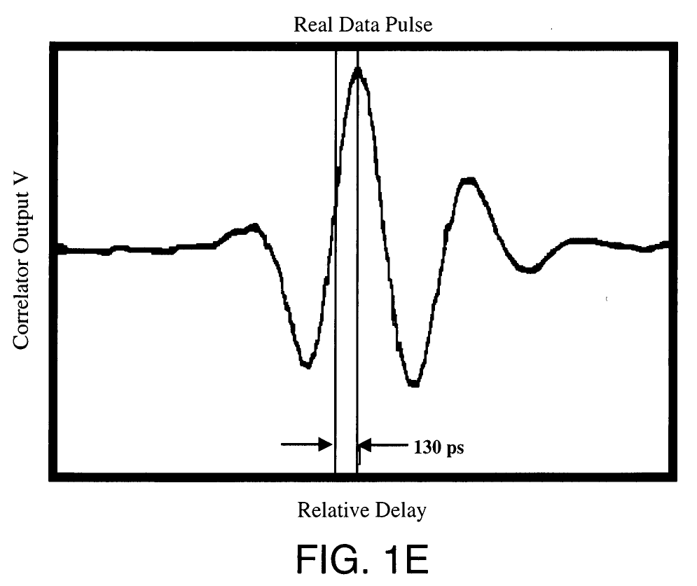

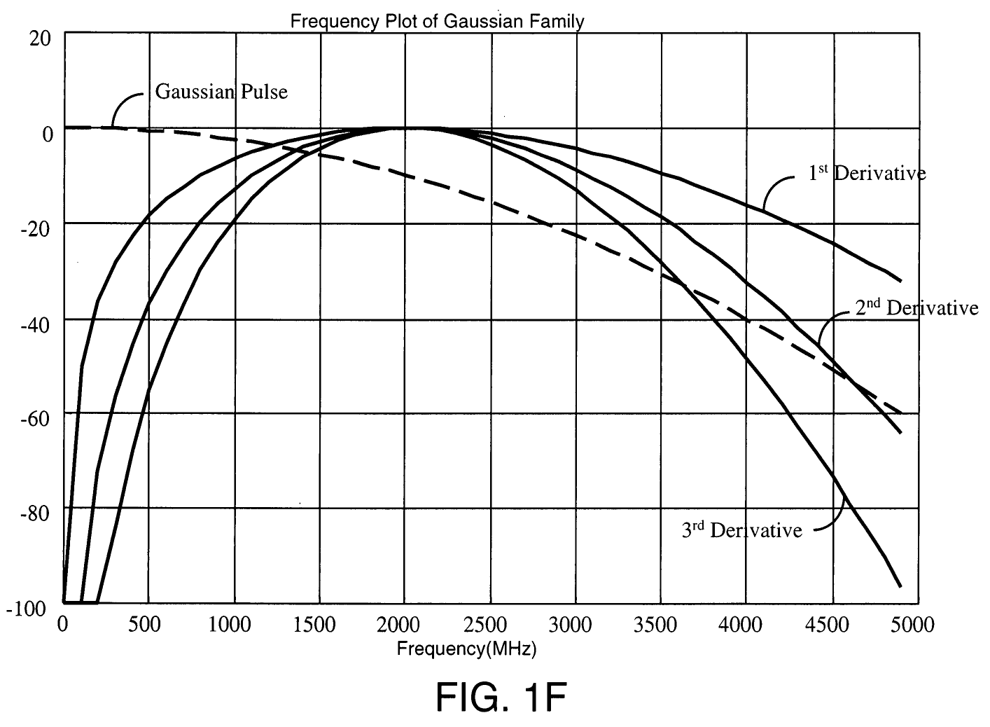

Impulse transmission systems are based on short, wide band pulses. Different pulse waveforms, or pulse types, may be employed to accommodate requirements of various applications. Typical ideal pulse types used in analysis include a Gaussian pulse doublet (also referred to as a Gaussian monocycle), pulse triplet, and pulse quadlet as depicted in FIGS. 1A through 1D. An actual received waveform that closely resembles the theoretical pulse quadlet is shown in FIG. 1E. A pulse type may also be a wavelet set produced by combining two or more pulse waveforms (e.g., a doublet/triplet wavelet set), or families of orthogonal wavelets. Additional pulse designs include chirped pulses and pulses with multiple zero crossings, or bursts of cycles. These different pulse types may be produced by methods described in the patent documents referenced above or by other methods understood by one skilled in the art.

For analysis purposes, it is convenient to model pulse waveforms in an ideal manner. For example, the transmitted waveform produced by supplying a step function into an ultra-wideband antenna may be modeled as a Gaussian monocycle. A Gaussian monocycle (normalized to a peak value of 1) may be described by:

$${f}_{mono} ( t ) = \sqrt{ⅇ} ( \frac{t}{σ} ) {ⅇ}^{\frac{- {1}^{2}}{2 {σ}^{2}}}$$

where σ is a time scaling parameter, t is time, and e is the natural logarithm base. FIG. 1F shows the power spectral density of the Gaussian pulse, doublet, triplet, and quadlet normalized to a peak density of 1. The normalized doublet (monocycle) is as follows:

$${F}_{mono} ( f ) = j ( 2 π ) \sqrt{ⅇ} σ f {ⅇ}^{- 2 {( π σ f )}^{2}}$$

Where Fmono( ) is the Fourier transform of fmono ( ), f is frequency, and j is the imaginary unit. The center frequency (fc), or frequency of peak spectral density, of the Gaussian monocycle is:

$${f}_{c} = \frac{1}{2 π σ}$$

Pulse Trains

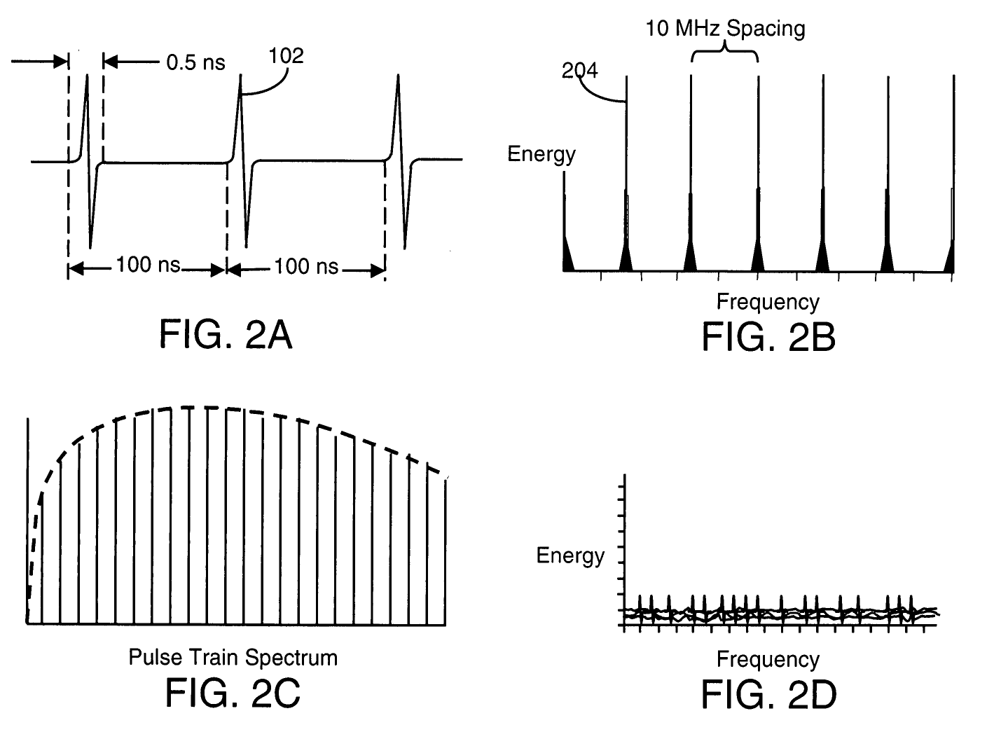

Impulse transmission systems may communicate one or more data bits with a single pulse; however, typically each data bit is communicated using a sequence of pulses, known as a pulse train. As described in detail in the following example system, the impulse radio transmitter produces and outputs a train of pulses for each bit of information. FIGS. 2A and 2B are illustrations of the output of a typical 10 megapulses per second (Mpps) system with uncoded, unmodulated pulses, each having a width of 0.5 nanoseconds (ns). FIG. 2A shows a time domain representation of the pulse train output. FIG. 2B illustrates that the result of the pulse train in the frequency domain is to produce a spectrum comprising a set of comb lines spaced at the frequency of the 10 Mpps pulse repetition rate. When the full spectrum is shown, as in FIG. 2C, the envelope of the comb line spectrum corresponds to the curve of the single Gaussian monocycle spectrum in FIG. 1F. For this simple uncoded case, the power of the pulse train is spread among roughly two hundred comb lines. Each comb line thus has a small fraction of the total power and presents much less of an interference problem to a receiver sharing the band. It can also be observed from FIG. 2A that impulse transmission systems may have very low average duty cycles, resulting in average power lower than peak power. The duty cycle of the signal in FIG. 2A is 0.5%, based on a 0.5 ns pulse duration in a 100 ns interval.

The signal of an uncoded, unmodulated pulse train may be expressed:

$$s ( t ) = a {\sum }_{i = 1}^{n} w ( c ( t - {iT}_{f} ) , b )$$

where i is the index of a pulse within a pulse train of n pulses, a is pulse amplitude, b is pulse type, c is a pulse width scaling parameter, w(t, b) is the normalized pulse waveform, and Tf is pulse repetition time, also referred to as frame time.

The Fourier transform of a pulse train signal over a frequency bandwidth of interest may be determined by summing the phasors of the pulses for each code time shift, and multiplying by the Fourier transform of the pulse function:

$$S ( f ) = a \vert {\sum }_{i = 1}^{n} {ⅇ}^{- j 2 π {fiT}_{f}} \vert W ( f )$$

where S(f) is the amplitude of the spectral response at a given frequency, f is the frequency being analyzed, T_{f} is the relative time delay of each pulse from the start of time period, W(f) is the Fourier transform of the pulse, w(t,b), and n is the total number of pulses in the pulse train.

A pulse train can also be characterized by its autocorrelation and cross-correlation properties. Autocorrelation properties pertain to the number of pulse coincidences (i.e., simultaneous arrival of pulses) that occur when a pulse train is correlated against an instance of itself that is offset in time. Of primary importance is the ratio of the number of pulses in the pulse train to the maximum number of coincidences that occur for any time offset across the period of the pulse train. This ratio is commonly referred to as the main-lobe-to-peak-side-lobe ratio, where the greater the ratio, the easier it is to acquire and track a signal.

Cross-correlation properties involve the potential for pulses from two different signals simultaneously arriving, or coinciding, at a receiver. Of primary importance are the maximum and average numbers of pulse coincidences that may occur between two pulse trains. As the number of coincidences increases, the propensity for data errors increases. Accordingly, pulse train cross-correlation properties are used in determining channelization capabilities of impulse transmission systems (i.e., the ability to simultaneously operate within close proximity).

Coding

Specialized coding techniques can be employed to specify temporal and/or non-temporal pulse characteristics to produce a pulse train having certain spectral and/or correlation properties. For example, by employing a Pseudo-Noise (PN) code to vary inter-pulse spacing, the energy in the uncoded comb lines presented in FIG. 2B and 2C can be distributed to other frequencies as depicted in FIG. 2D, thereby decreasing the peak spectral density within a bandwidth of interest. Note that the spectrum retains certain properties that depend on the specific (temporal) PN code used. Spectral properties can be similarly affected by using non-temporal coding (e.g., inverting certain pulses).

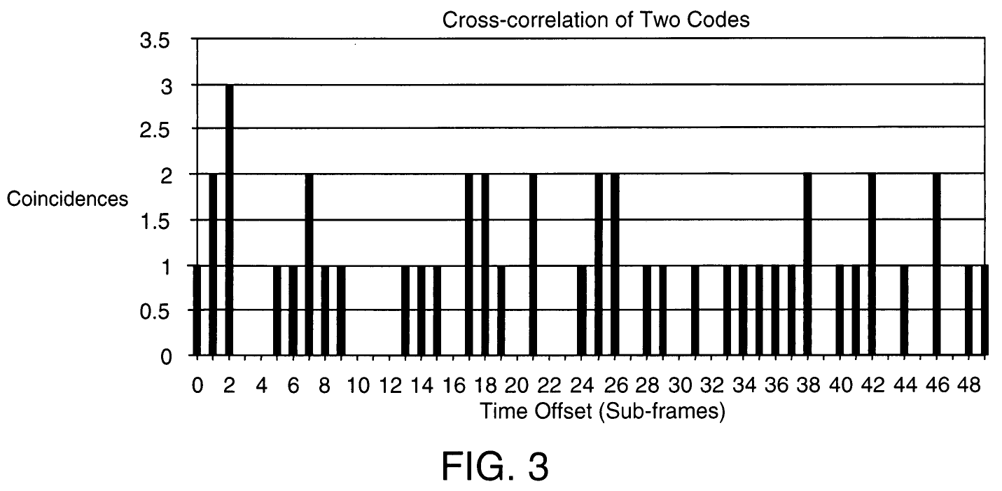

Coding provides a method of establishing independent communication channels. Specifically, families of codes can be designed such that the number of pulse coincidences between pulse trains produced by any two codes will be minimal. For example, FIG. 3 depicts cross-correlation properties of two codes that have no more than four coincidences for any time offset. Generally, keeping the number of pulse collisions minimal represents a substantial attenuation of the unwanted signal.

Coding can also be used to facilitate signal acquisition. For example, coding techniques can be used to produce pulse trains with a desirable main-lobe-to-side-lobe ratio. In addition, coding can be used to reduce acquisition algorithm search space.

Coding methods for specifying temporal and non-temporal pulse characteristics are described in applications titled “A Method and Apparatus for Positioning Pulses in Time,” application Ser. No. 09/592,249, and “A Method for Specifying Non-Temporal Pulse Characteristics,” application Ser. No. 09/592,250, both filed Jun. 12, 2000, and both of which are incorporated herein by reference.

Typically, a code consists of a number of code elements having integer or floating-point values. A code element value may specify a single pulse characteristic or may be subdivided into multiple components, each specifying a different pulse characteristic. Code element or code component values typically map to a pulse characteristic value layout that may be fixed or non-fixed and may involve value ranges, discrete values, or a combination of value ranges and discrete values. A value range layout specifies a range of values that is divided into components that are each subdivided into subcomponents, which can be further subdivided, as desired. In contrast, a discrete value layout involves uniformly or non-uniformly distributed discrete values. A non-fixed layout (also referred to as a delta layout) involves delta values relative to some reference value. Fixed and non-fixed layouts, and approaches for mapping code element/component values, are described in applications, titled “Method for Specifying Pulse Characteristics using Codes,” application Ser. No. 09/592,290 and “A Method and Apparatus for Mapping Pulses to a Non-Fixed Layout,” application Ser. No. 09/591,691, both filed on Jun. 12, 2000, both of which are incorporated herein by reference.

A fixed or non-fixed characteristic value layout may include a non-allowable region within which a pulse characteristic value is disallowed. A method for specifying non-allowable regions is described in U.S. Pat. No. 6,636,567 (issued Oct. 21, 2003) titled: “A Method for Specifying Non-Allowable Pulse Characteristics,” and incorporated herein by reference. A related method that conditionally positions pulses depending on whether code elements map to non-allowable regions is described in application, titled “A Method and Apparatus for Positioning Pulses Using a Layout having Non-Allowable Regions,” application Ser. No. 09/592,248 filed Jun. 12, 2000, and incorporated herein by reference.

The signal of a coded pulse train can be generally expressed by:

$${s}_{tr} ( t ) = {\sum }_{i} {( - 1 )}^{{f}_{i}} {a}_{i} w ( {c}_{i} ( t - {T}_{i} ) , {b}_{i} )$$

where str(t) is the coded pulse train signal, i is the index of a pulse within the pulse train, (−1)fi, ai, bi, ci, and ω(t,bi) are the coded polarity, pulse amplitude, pulse type, pulse width, and normalized pulse waveform of the i'th pulse, and Ti is the coded time shift of the ith pulse. Various numerical code generation methods can be employed to produce codes having certain correlation and spectral properties. Detailed descriptions of numerical code generation techniques are included in a patent application titled “A Method and Apparatus for Positioning Pulses in Time,” application Ser. No. 09/592,248, filed Jun. 12, 2000, and incorporated herein by reference.

It may be necessary to apply predefined criteria to determine whether a generated code, code family, or a subset of a code is acceptable for use with a given UWB application. Criteria may include correlation properties, spectral properties, code length, non-allowable regions, number of code family members, or other pulse characteristics. A method for applying predefined criteria to codes is described in U.S. Pat. No. 6,636,566 (issued Oct. 21, 2003), titled “A Method and Apparatus for Specifying Pulse Characteristics using a Code that Satisfies Predefined Criteria,” and incorporated herein by reference.

In some applications, it may be desirable to employ a combination of codes. Codes may be combined sequentially, nested, or sequentially nested, and code combinations may be repeated. Sequential code combinations typically involve switching from one code to the next after the occurrence of some event and may also be used to support multicast communications. Nested code combinations may be employed to produce pulse trains having desirable correlation and spectral properties. For example, a designed code may be used to specify value range components within a layout and a nested pseudorandom code may be used to randomly position pulses within the value range components. With this approach, correlation properties of the designed code are maintained since the pulse positions specified by the nested code reside within the value range components specified by the designed code, while the random positioning of the pulses within the components results in particular spectral properties. A method for applying code combinations is described in US. Pat. No. 6,671,310 (issued Dec. 30, 2003), titled “A Method and Apparatus for Applying Codes Having Pre-Defined Properties,” and incorporated herein by reference.

Modulation

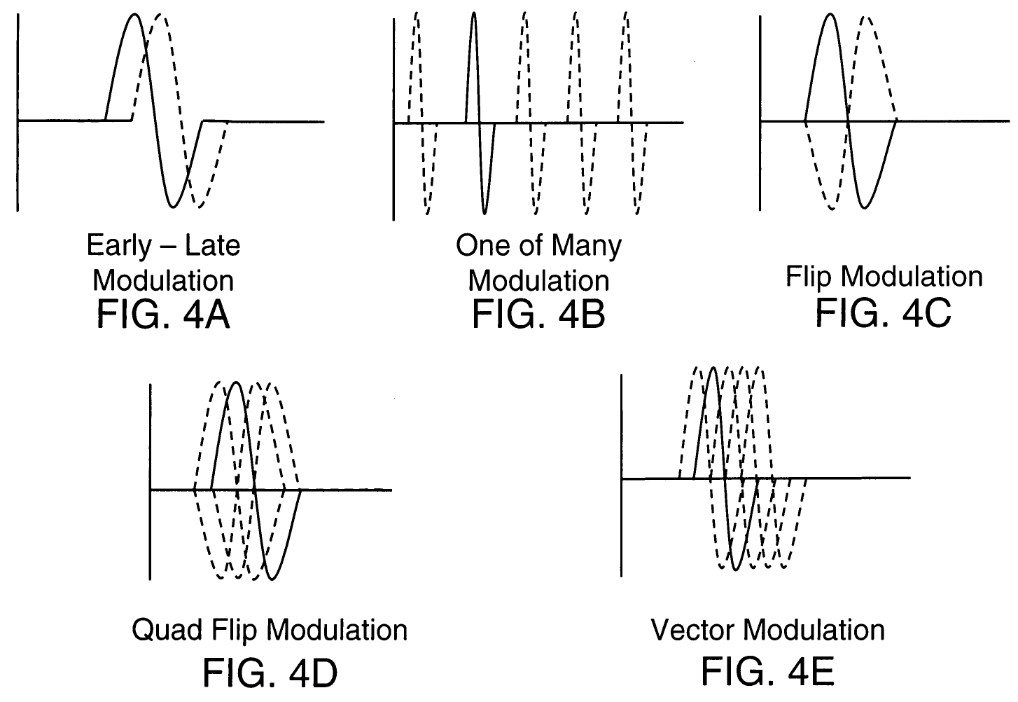

Various aspects of a pulse waveform may be modulated to convey information and to further minimize structure in the resulting spectrum. Amplitude modulation, phase modulation, frequency modulation, time-shift modulation and M-ary versions of these were proposed in U.S. Pat. No. 5,677,927 to Fullerton et al., previously incorporated by reference. Time-shift modulation can be described as shifting the position of a pulse either forward or backward in time relative to a nominal coded (or uncoded) time position in response to an information signal. Thus, each pulse in a train of pulses is typically delayed a different amount from its respective time base clock position by an individual code delay amount plus a modulation time shift. This modulation time shift is normally very small relative to the code shift. In a 10 Mpps system with a center frequency of 2 GHz, for example, the code may command pulse position variations over a range of 100 ns, whereas, the information modulation may shift the pulse position by 150 ps. This two-state ‘early-late’ form of time shift modulation is depicted in FIG. 4A.

A generalized expression for a pulse train with ‘early-late’ time-shift modulation over a data symbol time is:

$${s}_{tr} ( t ) = {\sum }_{i = 1}^{{N}_{s}} {( - 1 )}^{{f}_{i}} {a}_{i} w ( {c}_{i} ( t - {T}_{i} - δ {d}_{k} ) , {b}_{i} )$$

where k is the index of a data symbol (e.g., bit), i is the index of a pulse within the data symbol, Nₛ is the number of pulses per symbol, (−1)fᵢ is a coded polarity (flipping) pattern (sequence), aᵢ is a coded amplitude pattern, bᵢ is a coded pulse type (shape) pattern, cᵢ is a coded pulse width pattern, and w(t,bᵢ) is a normalized pulse waveform of the ith pulse, Tⱼ) is the coded time shift of the i'th pulse, δ is the time shift added when the transmitted symbol is 1 (instead of 0), dₖ is the data (i.e., 0 or 1) transmitted by the transmitter. In this example, the data value is held constant over the -symbol interval. Similar expressions can be derived to accommodate other proposed forms of modulation.

An alternative form of time-shift modulation can be described as One-of-Many Position Modulation (OMPM). The OMPM approach, shown in FIG. 4B, involves shifting a pulse to one of N possible modulation positions about a nominal coded (or uncoded) time position in response to an information signal, where N represents the number of possible states. For example, if N were four (4), two data bits of information could be conveyed. For further details regarding OMPM, see “Apparatus, System and Method for One-of-Many Position Modulation in an Impulse Radio Communication System,” filed Jun. 7, 2000, which is incorporated herein by reference.

An impulse radio communications system can employ flip modulation techniques to convey information. The simplest flip modulation technique involves transmission of a pulse or an inverted (or flipped) pulse to represent a data bit of information, as depicted in FIG. 4C. Flip modulation techniques may also be combined with time-shift modulation techniques to create two, four, or more different data states. One such flip with shift modulation technique is referred to as Quadrature Flip Time Modulation (QFTM). The QFTM approach is illustrated in FIG. 4D. Flip modulation techniques are further described in patent application titled “Apparatus, System and Method for Flip Modulation in an Impulse Radio Communication System,” application Ser. No. 09/537,692, filed Mar. 29, 2000, which is incorporated herein by reference.

Vector modulation techniques may also be used to convey information. Vector modulation includes the steps of generating and transmitting a series of time-modulated pulses, each pulse delayed by one of at least four pre-determined time delay periods and representative of at least two data bits of information, and receiving and demodulating the series of time-modulated pulses to estimate the data bits associated with each pulse. Vector modulation is shown in FIG. 4E. Vector modulation techniques are further described in U.S. Pat. No. 6,763,057, issued Jul. 13, 2004, titled “Vector Modulation System and Method for Wideband Impulse Radio Communications,” which is incorporated herein by reference.

Reception and Demodulation

Impulse radio systems operating within close proximity to each other may cause mutual interference. While coding minimizes mutual interference, the probability of pulse collisions increases as the number of coexisting impulse radio systems rises. Additionally, various other signals may be present that cause interference. Impulse radios can operate in the presence of mutual interference and other interfering signals, in part because they typically do not depend on receiving every transmitted pulse. Except for single pulse per bit systems, impulse radio receivers perform a correlating, synchronous receiving function (at the RF level) that uses sampling and combining, or integration, of many pulses to recover transmitted information. Typically, 1 to 1000 or more pulses are integrated to yield a single data bit thus diminishing the impact of individual pulse collisions, where the number of pulses that must be integrated to successfully recover transmitted information depends on a number of variables including pulse rate, bit rate, range and interference levels.

Interference Resistance

Besides providing channelization and energy smoothing, coding makes impulse radios highly resistant to interference by enabling discrimination between intended impulse transmissions and interfering transmissions. This property is desirable since impulse radio systems must share the energy spectrum with conventional radio systems and with other impulse radio systems.

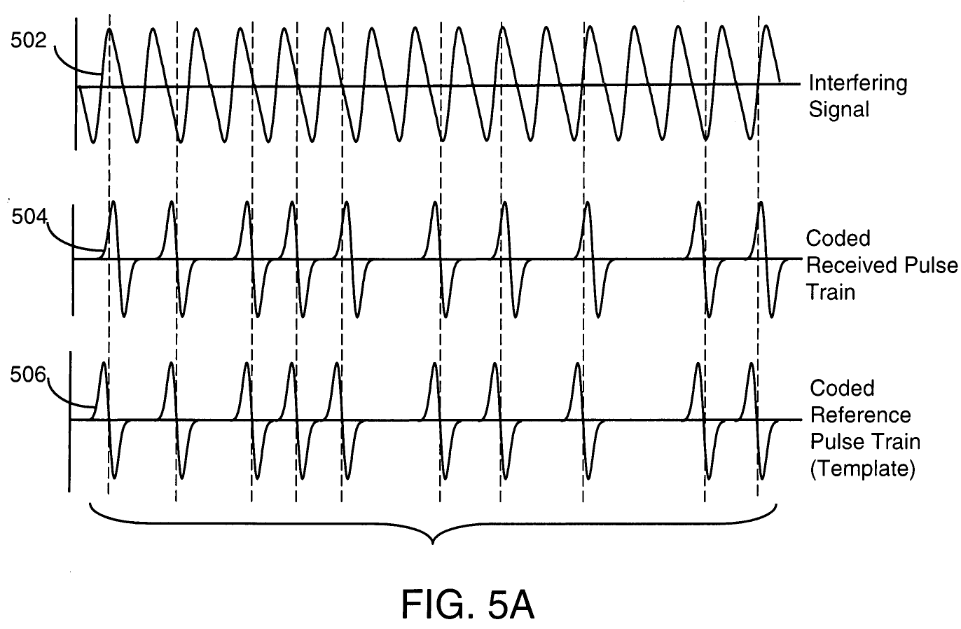

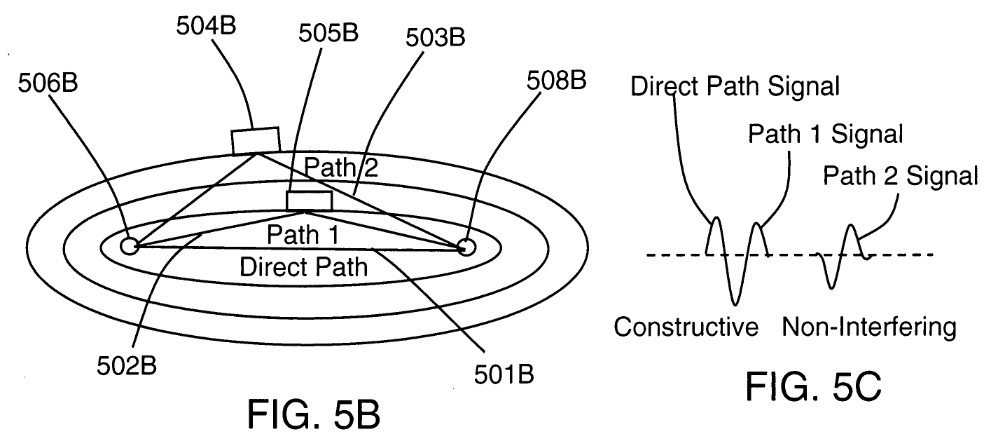

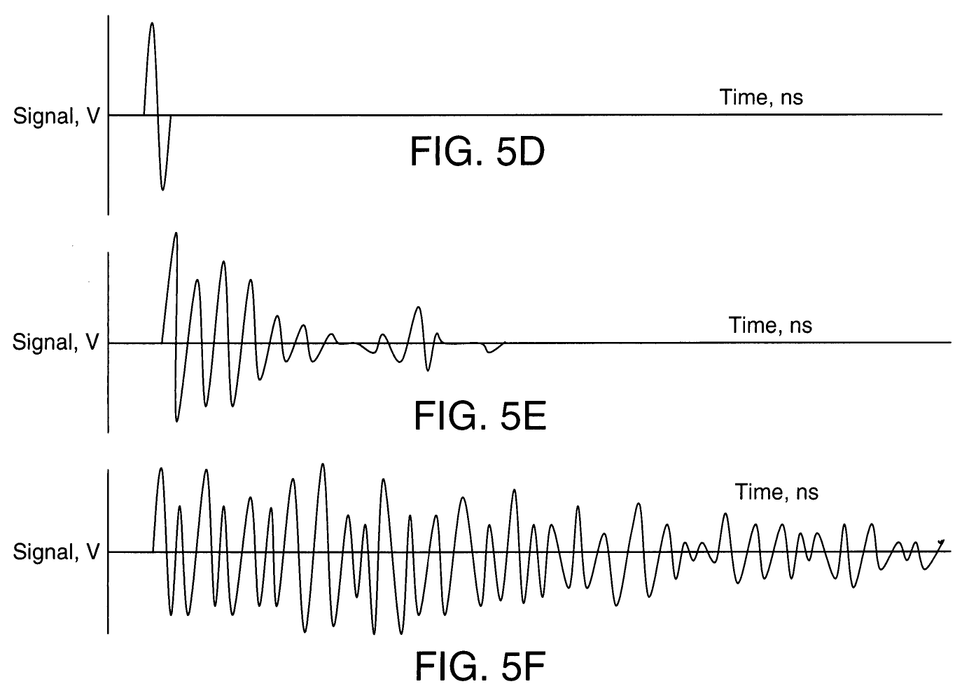

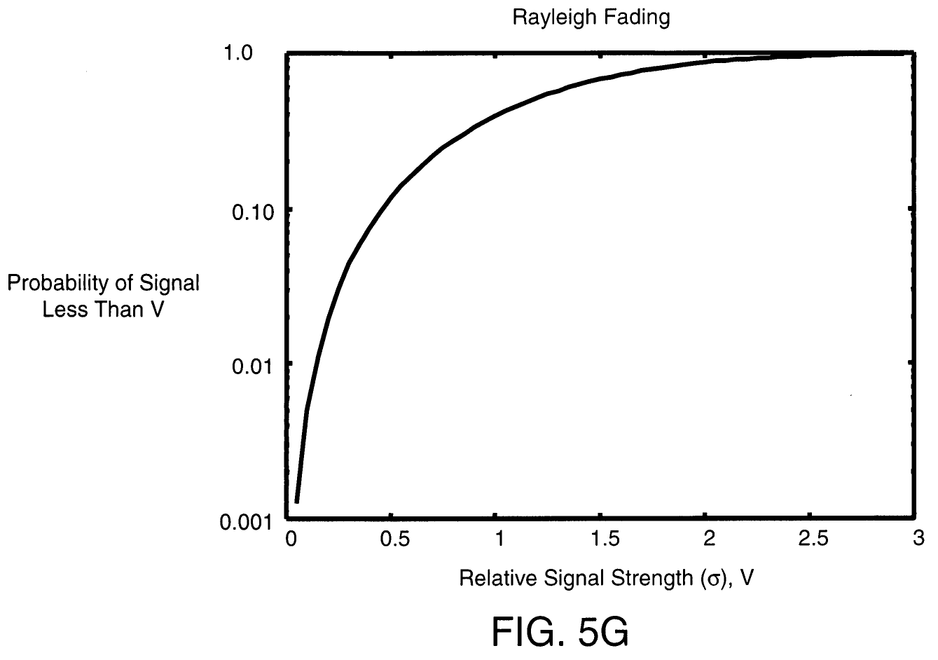

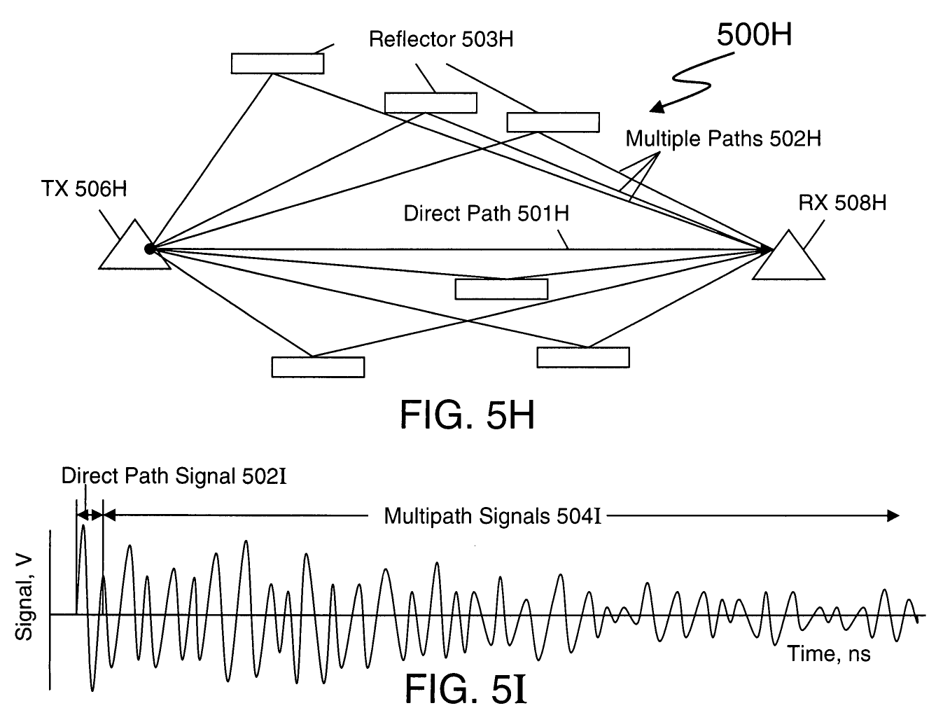

FIG. 5A illustrates the result of a narrow band sinusoidal interference signal 502 overlaying an impulse radio signal 504. At the impulse radio receiver, the input to the cross correlation would include the narrow band signal 502 and the received ultrawide-band impulse radio signal 504. The input is sampled by the cross correlator using a template signal 506 positioned in accordance with a code. Without coding, the cross correlation would sample the interfering signal 502 with such regularity that the interfering signals could cause interference to the impulse radio receiver. However, when the transmitted impulse signal is coded and the impulse radio receiver template signal 506 is synchronized using the identical code, the receiver samples the interfering signals non-uniformly. The samples from the interfering signal add incoherently, increasing roughly according to the square root of the number of samples integrated. The impulse radio signal samples, however, add coherently, increasing directly according to the number of samples integrated. Thus, integrating over many pulses overcomes the impact of interference.

Processing Gain

Impulse radio systems have exceptional processing gain due to their wide spreading bandwidth. For typical spread spectrum systems, the definition of processing gain, which quantifies the decrease in channel interference when wide-band communications are used, is the ratio of the bandwidth of the channel to the bit rate of the information signal. For example; a conventional narrow band direct sequence spread spectrum system with a 10 kbps data rate and a 10 MHz spread bandwidth yields a processing gain of 1000, or 30 dB. However, far greater processing gains are achieved by impulse radio systems, where the same 10 kbps data rate is spread across a much greater 2 GHz spread bandwidth, resulting in a theoretical processing gain of 200,000, or 53 dB.

Capacity

It can be shown theoretically, using signal-to-noise arguments, that for an impulse radio system with an information rate of a few tens of kbps, thousands of simultaneous channels could be available as a result of its exceptional processing gain.

The average output signal-to-noise ratio of a reference impulse radio receiver may be calculated for randomly selected time-hopping codes as a function of the number of active users, Nu, as:

$${S}_{out} ( {N}_{u} ) = \frac{1}{\frac{1}{{S}_{out} ( 1 )} + \frac{1}{{N}_{s}} \frac{{σ}_{a}^{2}}{{m}_{p}^{2}} {\sum }_{k = 2}^{{N}_{u}} ( \frac{{A}_{k}}{{A}_{1}} )}$$

where Ns is the number of pulses integrated per bit of information, A1 is the received amplitude of the desired transmitter, Ak is the received amplitude of interfering transmitter k's signal at the reference receiver, and σ_{rec}² is the variance of the receiver noise component at the pulse train integrator output in the absence of an interfering transmitter. The waveform-dependent parameters mp and σₐ² are given by

$${m}_{p} = {\int }_{- ∞}^{∞} w ( t ) [ w ( t ) - w ( t - δ ) ] ⅆ t$$

and

$${σ}_{a}^{2} = {T}_{f}^{- 1} {\int }_{- ∞}^{∞} {[ {\int }_{- ∞}^{∞} w ( t - s ) υ ( t ) ⅆ t ]}^{2} ⅆ s ,$$

where w(t) is the transmitted waveform, υ(t)=w(t)−w(t−δ) is the template signal waveform, δ is the modulation time shift between a digital one and a zero value data bit, Tf is the pulse repetition time, or frame time, and s is an integration parameter. The output signal to noise ratio that one might observe in the absence of interference is given by:

$${S}_{out} ( 1 ) = \frac{{( {A}_{1} {N}_{s} {m}_{p} )}^{2}}{{σ}_{rec}^{2}}$$

Where, σ_{rec}² is the variance of the receiver noise component at the pulse train integrator output in the absence of an interfering transmitter. Further details of this analysis can be found in R. A. Scholtz, “Multiple Access with Time-Hopping Impulse Modulation,” Proc. MILCOM, Boston, Mass., Oct. 11-14, 1993.

Multipath and Propagation

One of the advantages of impulse radio is its resistance to multipath fading effects. Conventional narrow band systems are subject to multipath through the Rayleigh fading process, where the signals from many delayed reflections combine at the receiver antenna according to their seemingly random relative phases resulting in possible summation or possible cancellation, depending on the specific propagation to a given location. Multipath fading effects are most adverse where a direct path signal is weak relative to multipath signals, which represents a substantial portion of the potential coverage area of a typical radio system. In a mobile system, received signal strength fluctuates due to the changing mix of multipath signals that vary as the mobile units position varies relative to fixed transmitters, other mobile transmitters and signal-reflecting surfaces in the environment.

Impulse radios, however, can be substantially resistant to multipath effects. Impulses arriving from delayed multipath reflections typically arrive outside of the correlation time and, thus, may be ignored. This process is described in detail with reference to FIGS. 5B and 5C. FIG. 5B illustrates a typical multipath situation, such as in a building, where there are many reflectors 504B, 505B. In this figure, a transmitter 506B transmits a signal that propagates along three paths, the direct path 501B, path 1 502B, and path 2 503B, to a receiver 508B, where the multiple reflected signals are combined at the antenna. The direct path 501B, representing the straight-line distance between the transmitter and receiver, is the shortest. Path 1 502B represents a multipath reflection with a distance very close to that of the direct path. Path 2 503B represents a multipath reflection with a much longer distance. Also shown are elliptical (or, in space, ellipsoidal) traces that represent other possible locations for reflectors that would produce paths having the same distance and thus the same time delay.

FIG. 5C illustrates the received composite pulse waveform resulting from the three propagation paths 501B, 502B, and 503B shown in FIG. 5B. In this figure, the direct path signal 501B is shown as the first pulse signal received. The path 1 and path 2 signals 502B, 503B comprise the remaining multipath signals, or multipath response, as illustrated. The direct path signal is the reference signal and represents the shortest propagation time. The path 1 signal is delayed slightly and overlaps and enhances the signal strength at this delay value. The path 2 signal is delayed sufficiently that the waveform is completely separated from the direct path signal. Note that the reflected waves are reversed in polarity. If the correlator template signal is positioned such that it will sample the direct path signal, the path 2 signal will not be sampled and thus will produce no response. However, it can be seen that the path 1 signal has an effect on the reception of the direct path signal since a portion of it would also be sampled by the template signal. Generally, multipath signals delayed less than one quarter wave (one quarter wave is about 1.5 inches, or 3.5 cm at 2 GHz center frequency) may attenuate the direct path signal. This region is equivalent to the first Fresnel zone in narrow band systems. Impulse radio, however, has no further nulls in the higher Fresnel zones. This ability to avoid the highly variable attenuation from multipath gives impulse radio significant performance advantages.

FIGS. 5D, 5E, and 5F represent the received signal from a TM-UWB transmitter in three different multipath environments. These figures are approximations of typical signal plots. FIG. 5D illustrates the received signal in a very low multipath environment. This may occur in a building where the receiver antenna is in the middle of a room and is a relatively short, distance, for example, one meter, from the transmitter. This may also represent signals received from a larger distance, such as 100 meters, in an open field where there are no objects to produce reflections. In this situation, the predominant pulse is the first received pulse and the multipath reflections are too weak to be significant. FIG. 5E illustrates an intermediate multipath environment. This approximates the response from one room to the next in a building. The amplitude of the direct path signal is less than in FIG. 5D and several reflected signals are of significant amplitude. FIG. 5F approximates the response in a severe multipath environment such as propagation through many rooms, from corner to corner in a building, within a metal cargo hold of a ship, within a metal truck trailer, or within an intermodal shipping container. In this scenario, the main path signal is weaker than in FIG. 5E. In this situation, the direct path signal power is small relative to the total signal power from the reflections.

An impulse radio receiver can receive the signal and demodulate the information using either the direct path signal or any multipath signal peak having sufficient signal-to-noise ratio. Thus, the impulse radio receiver can select the strongest response from among the many arriving signals. In order for the multipath signals to cancel and produce a null at a given location, dozens of reflections would have to be cancelled simultaneously and precisely while blocking the direct path, which is a highly unlikely scenario. This time separation of multipath signals together with time resolution and selection by the receiver permit a type of time diversity that virtually eliminates cancellation of the signal. In a multiple correlator rake receiver, performance is further improved by collecting the signal power from multiple signal peaks for additional signal-to-noise performance.

In a narrow band system subject to a large number of multipath reflections within a symbol (bit) time, the received signal is essentially a sum of a large number of sine waves of random amplitude and phase. In the idealized limit, the resulting envelope amplitude has been shown to follow a Rayleigh probability density as follows:

$$p ( r ) = \frac{r}{{σ}^{2}} exp ( \frac{- {r}^{2}}{2 {σ}^{2}} )$$

where r is the envelope amplitude of the combined multipath signals, and 2σ² is the expected value of the envelope power of the combined multipath signals. The Rayleigh distribution curve in FIG. 5G shows that 10% of the time, the signal is more than 10 dB attenuated. This suggests that a 10 dB fade margin is needed to provide 90% link reliability. Values of fade margin from 10 dB to 40 dB have been suggested for various narrow band systems, depending on the required reliability. Although multipath fading can be partially improved by such techniques as antenna and frequency diversity, these techniques result in additional complexity and cost.

In a high multipath environment such as inside homes, offices, warehouses, automobiles, trailers, shipping containers, or outside in an urban canyon or in other situations where the propagation is such that the received signal is primarily scattered energy, impulse radio systems can avoid the Rayleigh fading mechanism that limits performance of narrow band systems, as illustrated in FIG. 5H and 5I. FIG. 5H depicts an impulse radio system in a high multipath environment 500H consisting of a transmitter 506H and a receiver 508H. A transmitted signal follows a direct path 501H and reflects off of reflectors 503H via multiple paths 502H. FIG. 5I illustrates the combined signal received by the receiver 508H over time with the vertical axis being signal strength in volts and the horizontal axis representing time in nanoseconds. The direct path 501H results in the direct path signal 502I while the multiple paths 502H result in multipath signals 504I. UWB system can thus resolve the reflections into separate time intervals which can be received separately. Thus, the UWB system can select the strongest or otherwise most desirable reflection from among the numerous reflections. This yields a multipath diversity mechanism with numerous paths making it highly resistant to Rayleigh fading. Whereas, in a narrow band systems, the reflections arrive within the minimum time resolution of one bit or symbol time which results in a single vector summation of the delalyed signals with no inherent diversity.

Distance Measurement and Positioning

Impulse systems can measure distances to relatively fine resolution because of the absence of ambiguous cycles in the received waveform. Narrow band systems, on the other hand, are limited to the modulation envelope and cannot easily distinguish precisely which RF cycle is associated with each data bit because the cycle-to-cycle amplitude differences are so small they are masked by link or system noise. Since an impulse radio waveform has minimal multi-cycle ambiguity, it is feasible to determine waveform position to less than a wavelength in the presence of noise. This time position measurement can be used to measure propagation delay to determine link distance to a high degree of precision. For example, 30 ps of time transfer resolution corresponds to approximately centimeter distance resolution. See, for example, U.S. Pat. No. 6,133,876, issued Oct. 17, 2000, titled “System and Method for Position Determination by Impulse Radio,” and U.S. Pat. No. 6,111,536, issued Aug. 29, 2000, titled “System and Method for Distance Measurement by In-phase and Quadrature Signals in a Radio System,” both of which are incorporated herein by reference.

In addition to the methods articulated above, impulse radio technology in a Time Division Multiple Access (TDMA) radio system can achieve geo-positioning capabilities to high accuracy and fine resolution. This geo-positioning method is described in U.S. Pat. No. 6,300,903, issued Oct. 9, 2001, titled “System and Method for Person or Object Position Location Utilizing Impulse Radio,” which is incorporated herein by reference.

Power Control

Power control systems comprise a first transceiver that transmits an impulse radio signal to a second transceiver. A power control update is calculated according to a performance measurement of the signal received at the second transceiver. The transmitter power of either transceiver, depending on the particular setup, is adjusted according to the power control update. Various performance measurements are employed to calculate a power control update, including bit error rate, signal-to-noise ratio, and received signal strength, used alone or in combination. Interference is thereby reduced, which may improve performance where multiple impulse radios are operating in close proximity and their transmissions interfere with one another. Reducing the transmitter power of each radio to a level that produces satisfactory reception increases the total number of radios that can operate in an area without mutial interference. Reducing transmitter power can also increase transceiver efficiency.

For greater elaboration of impulse radio power control, see U.S. Pat. No. 6,539,213, issued Mar. 25, 2003, titled “System and Method for Impulse Radio Power Control,” which is incorporated herein by reference.

Exemplary Transceiver Implementation

Transmitter

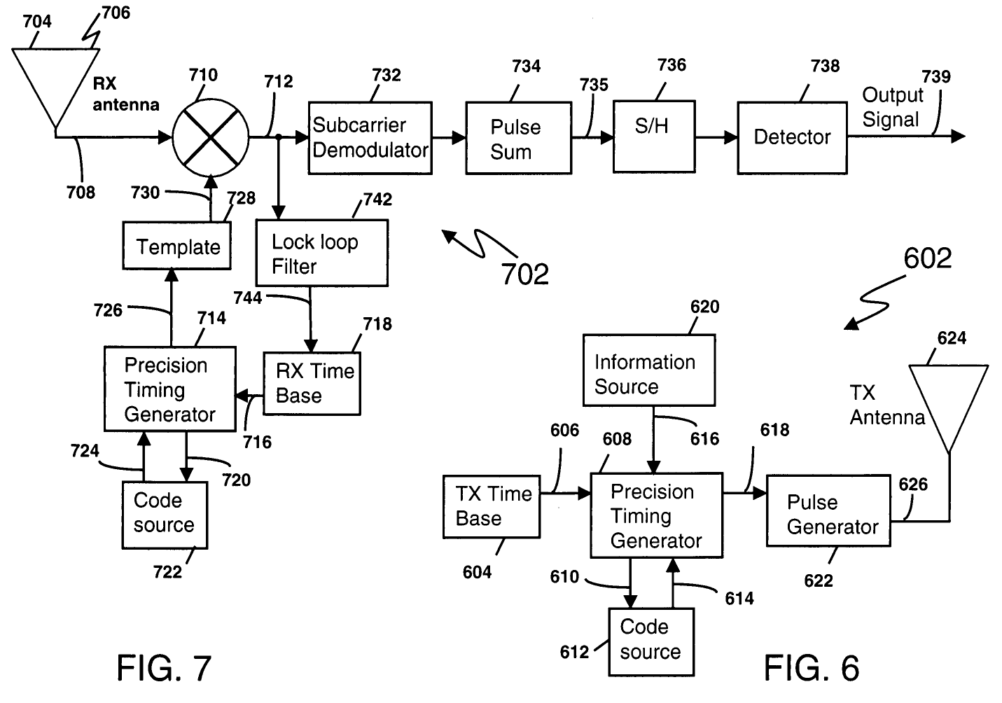

An exemplary embodiment of an impulse radio transmitter 602 of an impulse radio communication system having an optional subcarrier channel will now be described with reference to FIG. 6.

The transmitter 602 comprises a time base 604 that generates a periodic timing signal 606. The time base 604 typically comprises a voltage controlled oscillator (VCO), or the like, having a high timing accuracy and low jitter. The control voltage to adjust the VCO center frequency is set at calibration to the desired center frequency used to define the transmitter's nominal pulse repetition rate. The periodic timing signal 606 is supplied to a precision timing generator 608.

The precision timing generator 608 supplies synchronizing signals 610 to the code source 612 and utilizes the code source output 614, together with an optional, internally generated subcarrier signal, and an information signal 616, to generate a modulated, coded timing signal 618.

An information source 620 supplies the information signal 616 to the precision timing generator 608. The information signal 616 can be any type of intelligence, including digital bits representing voice, data, imagery, or the like, analog signals, or complex signals.

A pulse generator 622 uses the modulated, coded timing signal 618 as a trigger signal to generate output pulses. The output pulses are provided to a transmit antenna 624 via a transmission line 626 coupled thereto. The output pulses are converted into propagating electromagnetic pulses by the transmit antenna 624. The electromagnetic pulses (also called the emitted signal) propagate to an impulse radio receiver 702, such as shown in FIG. 7, through a propagation medium. In a preferred embodiment, the emitted signal is wide-band or ultrawide-band, approaching a monocycle pulse as in FIG. 1B. However, the emitted signal may be spectrally modified by filtering of the pulses, which may cause them to have more zero crossings (more cycles) in the time domain, requiring the radio receiver to use a similar waveform as the template signal for efficient conversion.

Receiver

An exemplary embodiment of an impulse radio receiver (hereinafter called the receiver) for the impulse radio communication system is now described with reference to FIG. 7.

The receiver 702 comprises a receive antenna 704 for receiving a propagated impulse radio signal 706. A received signal 708 is input to a cross correlator or sampler 710, via a receiver transmission line, coupled to the receive antenna 704. The cross correlation 710 produces a baseband output 712.

The receiver 702 also includes a precision timing generator 714, which receives a periodic timing signal 716 from a receiver time base 718. This time base 718 may be adjustable and controllable in time, frequency, or phase, as required by the lock loop in order to lock on the received signal 708. The precision timing generator 714 provides synchronizing signals 720 to the code source 722 and receives a code control signal 724 from the code source 722. The precision timing generator 714 utilizes the periodic timing signal 716 and code control signal 724 to produce a coded timing signal 726. The template generator 728 is triggered by this coded timing signal 726 and produces a train of template signal pulses 730 ideally having waveforms substantially equivalent to each pulse of the received signal 708. The code for receiving a given signal is the same code utilized by the originating transmitter to generate the propagated signal. Thus, the timing of the template pulse train matches the timing of the received signal pulse train, allowing the received signal 708 to be synchronously sampled in the correlator 710. The correlator 710 preferably comprises a multiplier followed by a short term integrator to sum the multiplier product over the pulse interval.

The output of the correlator 710 may be coupled to an optional subcarrier demodulator 732, which demodulates the subcarrier information signal from the optional subcarrier, when used. The purpose of the optional subcarrier process, when used, is to move the information signal away from DC (zero frequency) to improve immunity to low frequency noise and offsets. The output of the subcarrier demodulator is then filtered or integrated in the pulse summation stage 734. A digital system embodiment is shown in FIG. 7. In this digital system, a sample and hold 736 samples the output 735 of the pulse summation stage 734 synchronously with the completion of the summation of a digital bit or symbol. The output of sample and hold 736 is then compared with a nominal zero (or reference) signal output in a detector stage 738 to provide an output signal 739 representing the digital state of the output voltage of sample and hold 736.

The baseband signal 712 is also input to a lowpass filter 742 (also referred to as lock loop filter 742). A control loop comprising the lowpass filter 742, time base 718, precision timing generator 714, template generator 728, and correlator 710 is used to maintain proper timing between the received signal 708 and the template. The loop error signal 744 is processed by the loop filter to provide adjustments to the adjustable time base 718 to correct the relative time position. of the periodic timing signal 726 for best reception of the received signal 708.

In a transceiver embodiment, substantial economy can be achieved by sharing part or all of several of the functions of the transmitter 602 and receiver 702. Some of these include the time base 718, precision timing generator 714, code source 722, antenna 704, and the like.

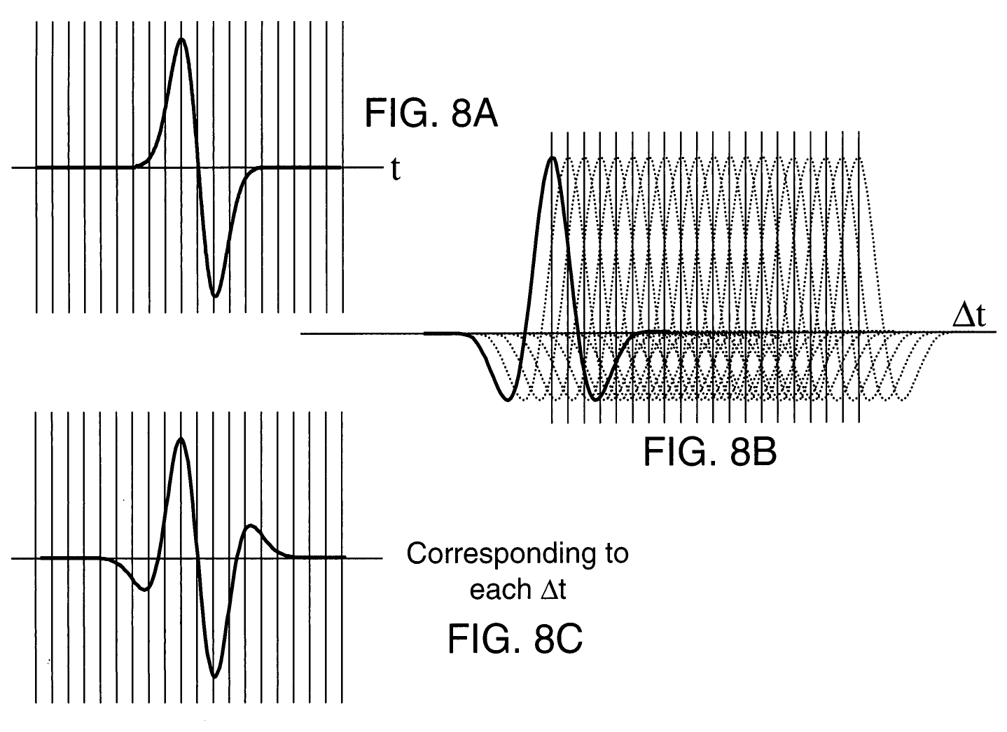

FIGS. 8A-8C illustrate the cross correlation process and the correlation function. FIG. 8A shows the waveform of a template signal. FIG. 8B shows the waveform of a received impulse radio signal at a set of several possible time offsets. FIG. 8C represents the output of the cross correlator for each of the time offsets of FIG. 8B. For any given pulse received, there is a corresponding point that is applicable on this graph. This is the point corresponding to the time offset of the template signal used to receive that pulse. Further examples and details of precision timing can be found described in U.S. Pat. No. 6,304,623, issued Oct. 16, 2001, titled “Precision Timing Generator System and Method,” which is incorporated herein by reference.

Because of the unique nature of impulse radio receivers, several modifications have been recently made to enhance system capabilities. Modifications include the utilization of multiple correlators to measure the impulse response of a channel to the maximum communications range of the system and to capture information on data symbol statistics. Further, multiple correlators enable rake pulse correlation techniques, more efficient acquisition and tracking implementations, various modulation schemes, and collection of time-calibrated pictures of received waveforms. For greater elaboration of multiple correlator techniques, see patent application titled “System and Method of using Multiple Correlator Receiver's in an Impulse Radio System”, application Ser. No. 09/537,264, filed Mar. 29, 2000, which is incorporated herein by reference.

Methods to improve the speed at which a receiver can acquire and lock onto an incoming impulse radio signal have been developed. In one approach, a receiver includes an adjustable time base to output a sliding periodic timing signal having an adjustable repetition rate and a decode timing modulator to output a decode signal in response to the periodic timing signal. The impulse radio signal is cross-correlated with the decode signal to output a baseband signal. The receiver integrates T samples of the baseband signal and a threshold detector uses the integration results to detect channel coincidence. A receiver controller stops sliding the time base when channel coincidence is detected. A counter and extra count logic, coupled to the controller, are configured to increment or decrement the address counter by one or more extra counts after each T pulses is reached in order to shift the code modulo for proper phase alignment of the periodic timing signal and the received impulse radio signal. This method is described in more detail in U.S. Pat. No. 5,832,035 to Fullerton, incorporated herein by reference.

In another approach, a receiver obtains a template pulse train and a received impulse radio signal. The receiver compares the template pulse train and the received impulse radio signal. The system performs a threshold check on the comparison result. If the comparison result passes the threshold check, the system locks on the received impulse radio signal. The system may also perform a quick check, a synchronization check, and/or a command check of the impulse radio signal. For greater elaboration of this approach, see U.S. Pat. No. 6,556,621, issued Apr. 29, 2003, titled “Method and System for Fast Acquisition of Ultra Wideband Signals”, which is incorporated herein by reference.

A receiver has been developed that includes a baseband signal converter device and combines multiple converter circuits and an RF amplifier in a single integrated circuit package. For greater elaboration of this receiver, see US. Pat. No. 6,421,389, issued Jul. 16, 2002, titled “Baseband Signal Converter for a Wideband Impulse Radio Receiver,” which is incorporated herein by reference.

Further details regarding advancements in UWB technology may be obtained from the following U.S. patent applications which are encorporated herein by reference:

U.S. patent application Ser. No.09/537,263, filed on Mar. 29, 2000, now U.S. Pat. No. 6,700,538 (issued Mar. 2, 2004) and entitled, “System and Method for Estimating Separation Distance Between Impulse Radios Using Impulse Signal Amplitude”;

U.S. patent application Ser. No.09/537,264, filed on Mar. 29, 2000, entitled, “System and Method of Using Multiple Correlator Receivers in an Impulse Radio System”;

U.S. patent application Ser. No.09/537,692, filed on Mar. 29, 2000, entitled, “Apparatus, System and Method for Flip Modulation in an Impulse Radio Communication System”;

U.S. patent application Ser. No.09/538,292, filed on Mar. 29, 2000, now U.S. Pat. No. 6,556,621 (issued Apr. 29, 2003) and entitled, “System for Fast Lock and Acquisition of Ultra-Wideband Signals”; and

U.S. patent application Ser. No.09/538,519, filed on Mar. 29, 2000, now U.S. Pat. No. 6,763,657 (issued Jul. 13, 2004) and entitled, “Vector Modulation System and Method for Wideband Impulse Radio Communications.” The present patent application incorporates by reference all of the above patent documents in their entirety.

For greater elaboration of impulse radio power control, see U.S. patent application Ser. No. 09/332,501, filed Jun. 14, 1999, now U.S. Pat. No. 6,539,213 (issued Mar. 25, 2003) and entitled “System and Method for Impulse Radio Power Control,” which is incorporated herein by reference.

For greater elaboration of fast acquisition, the reader is directed to the patent application entitled, “Method and System for Fast Acquisition of Ultra Wideband Signals”, U.S. patent application Ser. No.09/538,292, filed Mar. 29, 2000, now U.S. Pat. No. 6,556,621, issued Apr. 29, 2003. This patent application is incorporated herein by reference.

Signal acquisition and tracking techniques are further explained in U.S. patent application Ser. No. 10/955,118, titled System and Method for Fast Acquisition of Ultra Wideband Signals, filed Sep. 30, 2004, which is incorporated herein by reference.

Techniques for producing scans are further explained in U.S. Pat. No. 6,614,384 and U.S. patent application Ser. No.09/537,264, which are incorporated herein by reference.

System and Method for Locating Objects

The present invention is a system and method for locating objects and/or receiving data associated with an object. In brief, an antenna or similar device that can intercept or modify RF energy is caused to vary its properties in accordance with a predefined time sequence pattern that is associated with the object. The antenna device is located proximate to the object to be located. To locate the object, a wide band radar device is utilized to transmit a probe signal and receive and analyze the return signal to identify the predefined pattern and determine the range to the antenna and thus determine the range to the associated object. In a further embodiment, the antenna device properties may be modulated by information associated with the object, such as a serial number or the temperature of the device or other data. The radar device may then demodulate the information.

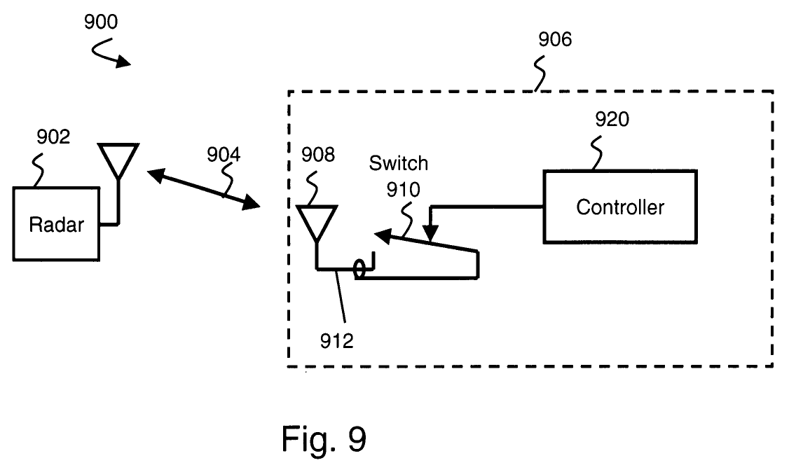

The details of the embodiments will now be described beginning with FIG. 9. FIG. 9 is an idealized illustration of the basic elements of the preferred embodiment of the present invention. Referring to FIG. 9, a wide band radar 902 transmits a pulse 904 in the direction of a reflective tag device 906. The pulse 904 is received by the tag antenna 908, generating a received pulse at the antenna terminals that is then coupled to a switch 910, possibly through an optional transmission line 912. Because the switch 910 is either open or closed, i.e. very high or very low in impedance by comparison with the impedance of the antenna or the optional transmission line 912, the switch 910 presents a substantial mismatch such that, ideally, all of the signal is reflected. Thus, signal is then reflected back to the tag antenna 908 as a reflected signal in accordance with the state of the switch 910. If the switch 910 is open the reflected signal is in phase with the received signal. If the switch 910 is closed, the reflected signal is inverted relative to the received signal as observed at the switch 910 contacts. Alternatively, one position of the switch 910 may produce a matched load—absorbing and not reflecting the pulse 904 signal. The matched load may be in series or in parallel with the switch 910, thus, the matched load may be one of two states (matched and open, or matched and closed) or may be a third state (matched, open, and closed). In a further alternative, the load may be varied in an analog manner.

The switch 910 is controlled by a controller 920 that sets the state of the switch 910 (open or closed) according to a predetermined time pattern. This time pattern may be, for example, a constant periodic frequency, (e.g. 10 kHz) or a code such as a PN code, as may be generated by a maximal length shift register, or other code, such as Kasami, or Gold code, or Barker code, or other pattern as appropriate for the application. Many such patterns are known by those skilled in the art. In a preferred embodiment, the selected code may have low autocorrelation side lobes or may be from a family of codes that have low autocorrelation side lobes and low cross correlation among members of the family.

The chip rate of the code pattern (e.g. 10 kilo-chips-per-second) will typically be very low relative to the center frequency of a typical received signal (e.g., 3 GHz.) This is not essential, but may be beneficial in many systems. A lower chip rate allows longer integration times for a given reference oscillator tolerance, which results in greater sensitivity and greater range. This benefit may be traded with 1/f noise sensitivity. Most semiconductor circuits exhibit an increase in noise figure as a function frequency as the frequency is lowered due to 1/f noise. 1/f noise typically begins at 10 kHz and is particulary troublesome below 1 kHz. A given receiver architecture should be examined for sensitivity to 1/f noise as part of the chip rate selection trade. It is a significant benefit of the invention that the system can be designed to operate at a frequency that is not substantially subject to 1/f noise.

A further benefit of the relatively low chip rate is that low chip rates allow implementations that consume very low battery power. CMOS logic consumes power substantially proportional to the clock frequency because power is consumed primarily during logic state transitions. Steady state conditions require only very small leakage currents to maintain the logic state. Thus, it is desirable that the system operate at a low clock frequency to minimize power consumption. Since 10 kHz is somewhat lower than the 32,768 Hz typically used for battery operated clock and watch devices, and since the logic requirements of this device are potentially less than that of an LCD wrist watch, it is reasonable to expect equal or better battery consumption performance from a simple implementation of the present invention using CMOS and FET components, i.e. a simple reflective tag could operate a year or more on a watch battery.

The transmitted probe signal from the radar device may take a number of forms. In a preferred embodiment, the transmitted signal is an ultra wideband pulse. The ultra wideband pulse is relatively discrete in time and lends itself to time gating or time sampling. The signal does not have to be a pulse, however and does not have to occupy an instantaneous ultra wide bandwidth. It is advantageous, however to span the necessary bandwidth during each logic state time or chip time of the tag device. A set of alternative signals includes a chirp pulse, a sequence of high rate coded pulses using a low autocorrelation side lobe code (such as a Barker code or Kassami code), and a swept sine wave signal. For illustration purposes the UWB pulse is utilized in this disclosure. The tag may be probed with a narrow band signal, however, ultra wideband allows range gating to identify separate tags and range determination to determine the range to the tag. Multiple UWB probes may triangulate to determine the tag position.

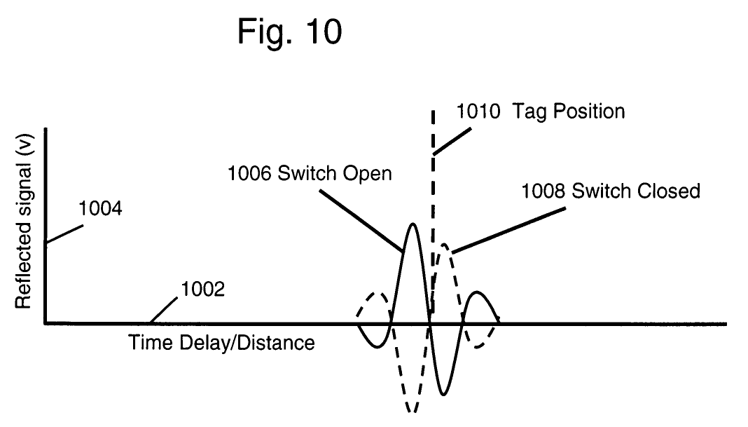

Referring now to FIG. 10, FIG. 10 is a depiction of two representative return signal waveforms in the radar receiver. The x axis 1002 represents the time delay between a transmitted pulse and a sample time for the radar receiver. The y axis 1004 represents the signal voltage at the output of the sampler. Curve 1006 represents the response for a tag with the switch open. Curve 1008 represents the response for a tag with the switch in the closed position. Time position 1010 represents a nominal tag distance which may be computed as the radar range to the reflection point, i.e. the switch element. Note that the two pulses 1006 and 1008 are opposite in polarity from one another. In a practical system, there is typically a component of the return pulse that does not invert that is not shown in this idealistic depiction.

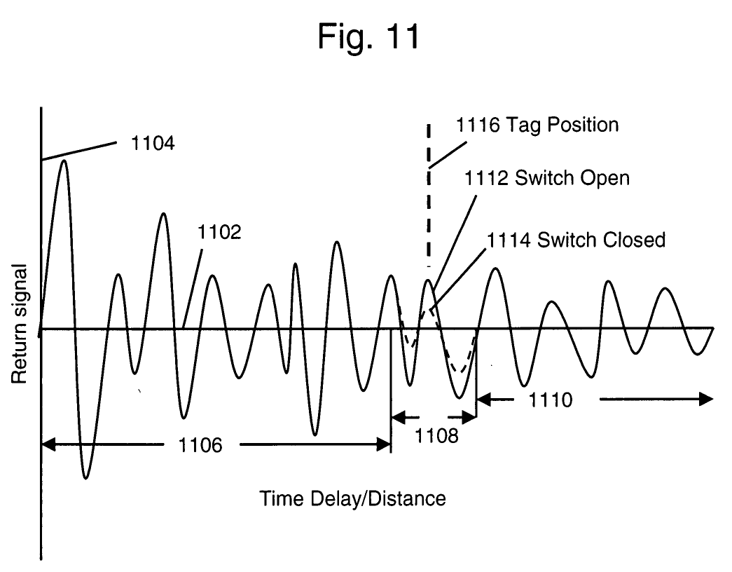

FIG. 11 depicts a typical radar reflection scan of a cluttered environment that includes a reflective tag. The x axis 1102 is time delay between the pulse signal and the receiver sampling time. The y axis 1104 is the sampled signal value. The scan of FIG. 11 shows the radar return for two tag states, for the switch open 1112 and for the switch closed 1114. The scan comprises three regions 1106, 1108, and 1110. The first region 1106 represents the clutter return from reflectors in the environment at close ranges where there is no tag. The clutter level can be substantial in a typical office, warehouse or home environment. Note that the response for the two tag states is the same in interval 1106. The second interval 1108 represents the region around the tag distance 1116 (time delay representing tag distance). The two radar return response levels 112, 114 are different in region 1108 as noted by the solid and broken lines. One switch position (switch open 1112) is depicted to have a higher response level, however, depending on the configuration, the other switch position may have a higher level. The particular response for a given situation depends on exactly how the phase of the tag response adds or subtracts from the total clutter response at the same distance. The third region 1110 represents the clutter return from distances greater than the tag distance 1116. Note that in the third region 1110 the tag state has no effect on the clutter return.

It is significant to note from FIG. 11 that the response from the tag in either state may be smaller than the response from clutter, making it difficult if not impossible to discern a tag from among the clutter except for the switching pattern of the tag. Although clutter response varies tremendously with even small changes in range, the clutter response is constant for a fixed range. The tag response, however, varies according to the switching pattern for a fixed range. Thus, the tag can be detected by looking for variations in return signal for a fixed range. Thermal noise and interference may also produce slight variations at a fixed range, so the tag is designed to switch with a known pattern that may be selected to overcome noise and interference.

It is also significant to note that the UWB radar is capable of receiving the pulse reflection from the tag at the tag range and rejecting clutter at other ranges. A narrow band radar would have to detect a tag among the clutter from all ranges summed together. Further, the UWB radar can separately detect two or more tags at separate ranges. A narrow band radar would receive all tags within reception range simultaneously. The UWB radar can receive a weaker tag response from a different range than a stronger tag response. A narrow band radar could not use range gating to isolate the weaker tag response.

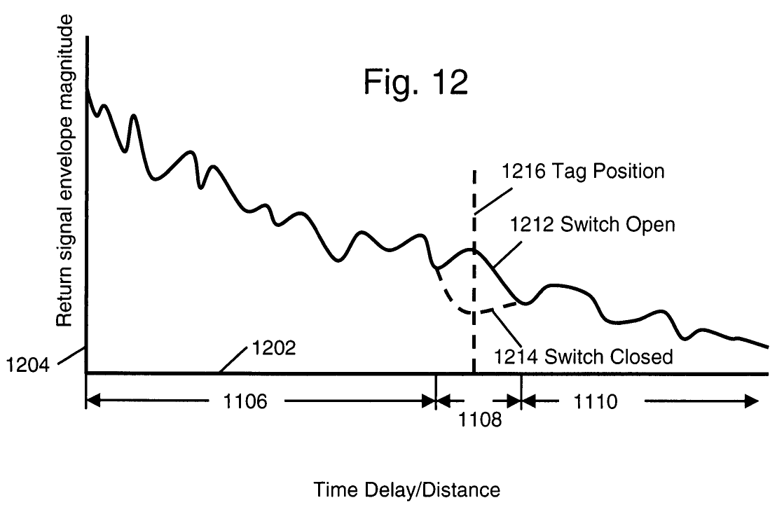

FIG. 12 depicts an exemplary magnitude plot of radar reflection scan of a cluttered environment that includes a reflective tag. The x axis 1202 is time delay values between the pulse signal and the receiver sampling time. The y axis 1204 is the envelope magnitude at a given time delay value. The magnitude plot of FIG. 12 roughly corresponds to the signal plot of FIG. 11. The scan of FIG. 12 shows the radar return for two tag states, for the switch open 1212 and for the switch closed 1214. The scan of FIG. 12 comprises three regions 1106, 1108, and 1110. Region 1106 is closer in range than the tag. Region 1108 includes the tag. Region 1110 is farther than the tag.

The signal envelope magnitude may be derived using Hilbert transform methods using a signal trace such as in FIG. 10 or FIG. 11. Alternatively, a magnitude plot may be derived from a dual correlator receiver wherein one correlator is delayed by about ¼ wave at the center frequency of the UWB signal. The Hilbert transform magnitude may be generated by first taking the Hilbert transform of the signal scan. The signal scan and Hilbert transform are then squared and summed to derive a magnitude plot (in power units.) A dual correlator receiver magnitude may be generated by squaring and summing the scans from the two channels. The magnitude plot may then be square root processed to derive a magnitude plot in voltage units. In one embodiment, an absolute value operation is substituted for the squaring operation.

Link Budget and Potential Range

Because UWB is typically limited in power by regulatory agencies and since the probing device is essentially a radar with 1/r⁴ path loss attenuation, the link budget is roughly as follows:

Path Loss

$$\begin{matrix}Lp 1 = 92.4 + 20 log ( km ) + 20 log ( GHz ) \\ = 38.4 + 20 log ( m ) at 2 GHz\end{matrix}$$

Two way path loss

$$\begin{matrix}Lp 2 = Lp 1 * Lp 1 \\ = 76.8 + 40 log ( m )\end{matrix}$$

Transmit Power=50 uw=−13 dBm
KTB=−174 dBm/Hz

Range=−13—−174−76.8=83 dB at 1 Hz bandwidth

Range=10^{(83/40)}=10²=100 m

The bandwidth relates to the integration time and impacts the potential data rate for the associated distance.

Table 1 illustrates the potential distance for several bandwidths and for thermal limited performance and for performance with a 20 dB margin.

TABLE 1

| | | |
|---|---|---|
| Bandwidth | Thermal Limit | 20 dB Margin |

| | | | | | |
|---|---|---|---|---|---|
| 1 | Hz | 100 | m | 30 | m |
| 10 | Hz | 10 | m | 3 | m |
| 100 | Hz | 1 | m | 0.3 | m |

In special circumstances, such as for emergency operations or for military opertions or where regulations are modified, such as underground in mines, higher power may be allowed, permitting longer ranges.

Directional antennas may further increase the range of a tag system.

It should also be noted that for tag detection or for very low rate data, the radar probe device may be designed to integrate (sum) the received signal indefinitely, for hours or longer if otherwise practical, resulting in increased range.

Basic Tag System

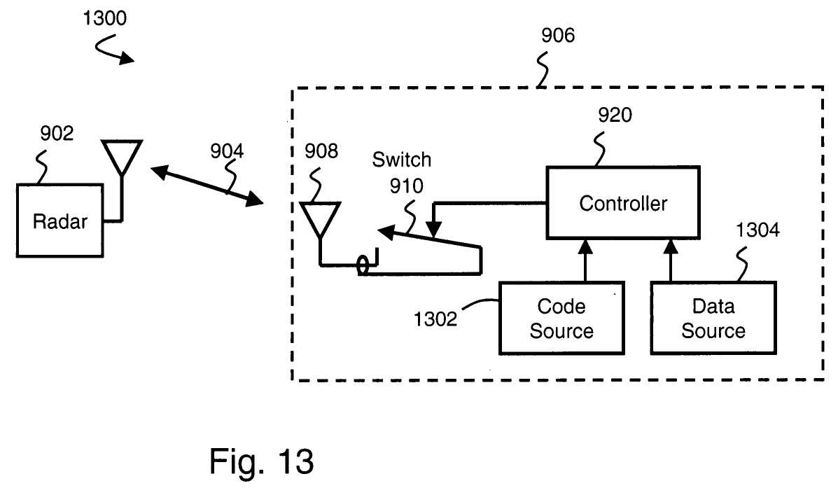

Turning now to FIG. 13. FIG. 13 illustrates a basic system utilizing a code and optionally conveying data associated with the object. The data may be a serial number associated with the tag, or a measurement such as for example, internal temperature or battery voltage, or data supplied by an external source, or other data in accordance with the application needs. A number of modulation formats may be used. The modulation may be analog or digital or a combination. The modulation may include clock information or clock information may be derived from the data stream. Digital data may be, for example, non-return to zero (NRZ), return to zero (RZ), Bi-Phase, Manchester, Miller coded, or may utilize a serial data protocol such as RS-232. The modulation may include a subcarrier.

In one embodiment, the data are used to modulate the polarity of a code sequence that in turn controls the switch. For example, given a code sequence of +,+,−,+ and a data sequence of 110, the resulting output sequence would be: +,+,−,+,+,+,−,+,−,−,+,−, where the + controls the switch to the open state and the—controls the switch to the closed state. Each sequential state may be referred to as a chip and a set of chips comprising one code modulo may be referred to as a symbol. The use of a code allows multiple tags to be distinguished from one another at the same range. The code may be of any length. Greater code lengths generally permit more tags to be distinguished from one another in a given area. Codes that may be used include such codes as Barker codes, Kassami codes, Gold codes, Pseudo-Noise sequences including maximal length sequences and other codes.

Referring to FIG. 13, FIG. 13 illustrates a code tag being probed by a radar device. The code tag 906 comprises a controller 920, a code source 1302, a switch 910, a tag antenna 908, and optionally a data source 1304. The controller 920 controls the operation of the switch 910. The switch 910 is coupled to the tag antenna 908. The controller 920 receives a code from the code source 1302 and may optionally receive data from the data source 1304. The controller 920 combines the code and data in accordance with a protocol and controls the switch 910 accordingly. A radar 902 sends a pulse 904 toward the tag antenna 908. The pulse 904 is received by the tag antenna 908 and coupled to the switch 910. Depending on the state of the switch 910, the pulse 904 is reflected in phase or inverted and transmitted again by the tag antenna 908. The reflected pulse 904 is then received by the radar.

The radar 902 typically sends a number of pulses 904 over a time interval to the tag device 906 and receives a number of reflected pulses 904 from the tag device 906. The sequence of reflected pulses 904 is then analyzed to determine the presence of a switching time pattern associated with the tag device 906. The switching time pattern may be as simple as a constant frequency square wave, or may involve complex codes and multiple state modulation formats.

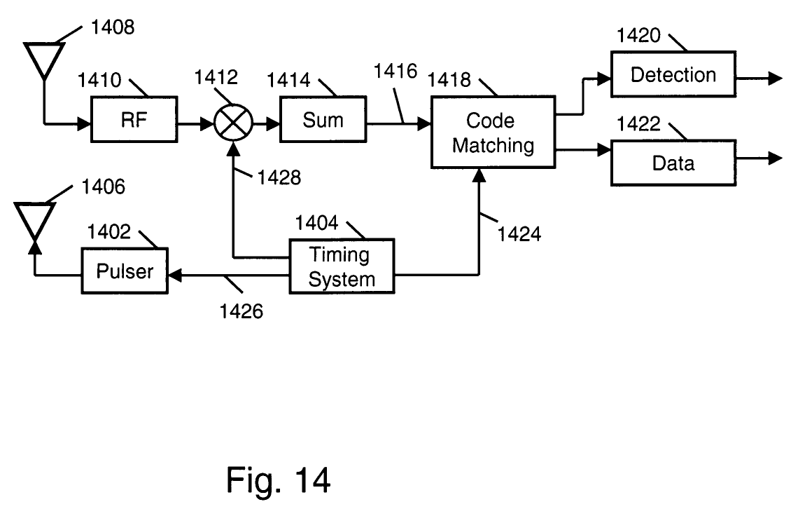

FIG. 14 is a simplified diagram of an exemplary radar in accordance with the present invention. Referring to FIG. 14, a pulser 1402 transmits a pulse 904 in accordance with timing signals 1426 from a timing system 1404. The pulse 904 is transmitted via an transmitting antenna 1406, which may be an omni-directional antenna or directive antenna. The pulse 904 is reflected by a tag (not shown) and received by a receiving antenna 1408. Separate transmitting antennas 1406 and receiving antennas 1408 are shown. Separate antennas avoid the necessity of a transmit/receive switch and other considerations that are necessary when a common antenna is shared. Alternatively, a common antenna may be shared between the transmitter and receiver if desired. The received signal is coupled through an RF front end 1410 comprising gain and filtering, if required for an particular application. The output of the RF front end 1410 is converted to baseband in a template correlation stage 1412 or alternatively sampled using techniques as are known for UWB systems. The timing system 1404 provides a delay timing signal 1428 which is delayed from the transmit pulse 904 time for receiving reflected signals at a predetermined range. The correlation stage 1412 shown may comprise a single correlator for discrete samples, or multiple parallel correlators for sampling at multiple delay times or correlator pairs for sampling I/Q delay pairs. Sampling and correlation include signal integration over the sampling period of the pulse. Under one alternative arrangement, correlation state 1412 is replaced by a tunnel diode having a detection threshold, which may be range gated by timing system 1404.

The sampled signal may be optionally summed by summer 1414 with other samples from prior reflected pulses from the same range to produce a summation signal 1416. The code matching 1418 process may comprise a single square wave gating process or may involve the decoding of a complex code. In some embodiments, the sum produced by summer 1414 is a partial summation, with the summation being completed as part of the code matching 1418. Code matching 1418 function may execute sequentially or by using parallel processing. Code matching 1418 typically utilizes correlation algorithms to match a sequence of received samples with the code pattern associated with the tag device 906.

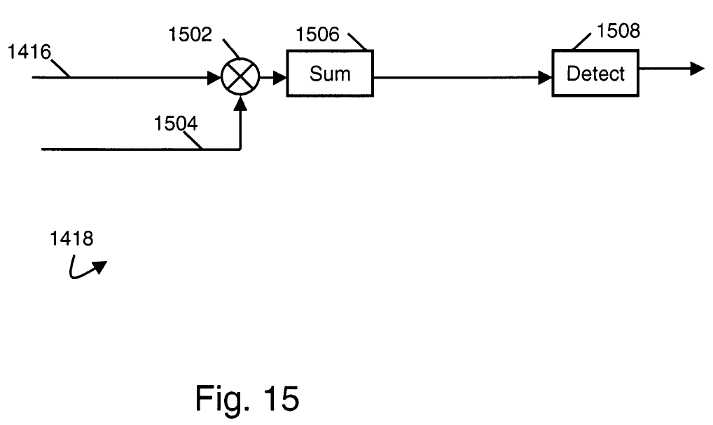

FIG. 15 illustrates an exemplary code matching process 1418 utilizing a single correlator. Referring to FIG. 15, a sequence of summation signal 1416 values is presented to the input of a multiplier 1502. A code pattern 1504 is presented to the other input of the multiplier 1502. The output of the multiplier 1502 is summed over an interval and the sum 1506 output is presented to a detector 1508. (Multiply and integration or summation is also called correlation) In one exemplary embodiment, the tag may switch at a constant 10 kHz rate. Thus the “code” presented to the multiplier 1502 is simply a 10 kHz square wave, or a repeating code of “1” and “−1” values repeated at a 10 kilo codes per second rate. If the radar is receiving a tag and the code pattern 1504 is in phase with the tag 906, the output of the multiplier 1502 will contain a rectified DC component proportional to the tag signal level. The sum 1506 process may be a filter, a moving average filter or a summation over an interval of time. The output of the sum 1506 is compared with a predetermined level to determine the presence of a tag device 906. Alternatively, the output may be compared with a level determined from background noise, such as for example a 5 sigma level. (5 times the standard deviation of the noise.) Background noise may be determined by using a different code, such as a different frequency (5 kHz) or orthogonal code. In a further alternative, the level may be adjusted in accordance with a constant false alarm rate.

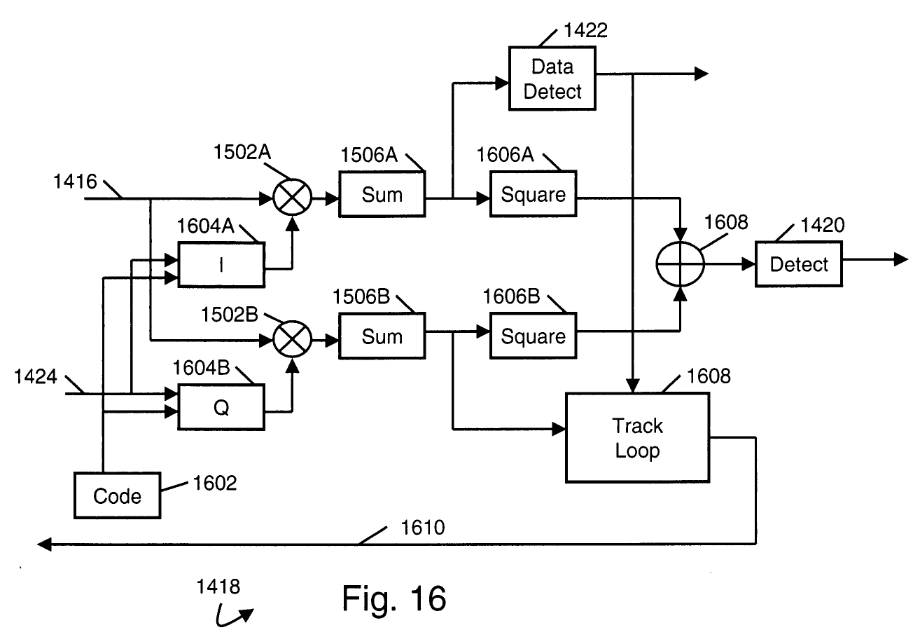

FIG. 16 is a block diagram of an I/Q code matching process 1418. The code matching process 1418 of FIG. 16 is capable of detecting tag 906 signals at all chip clock phases, thus avoiding the issue of being nonresponsive to signals ½ chip time (¼ cycle time) out of phase (tag clock cycles are not to be confused with UWB waveform cycles). Referring to FIG. 16, the output 1416 of the correlator 1412, or optional partial summation process 1414 is delivered to two multipliers 1502A and 1502B. A first multiplier 1502A receives and in-phase chip signal from an in-phase chip clock 1604A. A second multiplier 1502B receives an offset chip signal from an offset chip clock 1604B, offset ½ chip time (advanced or delayed) from the in phase chip signal. The chip signals are derived from a copy of the code 1602 and modulation used by the tag 906, but clocked by the receiver timing signals 1424. In a preferred embodiment, the chip signals are effectively a sequence of +1 and −1 values, and over one code modulo the chip signal preferably comprises an equal number of +1 and −1 values. By multiplying by +1 and −1 an equal number of times, a constant value received signal, such as from static clutter, will be removed.

The outputs of the multipliers 1506A and 1506B are squared 1606A and 1606B or alternatively rectified (absolute value) and summed 1608. The summed output is then compared by threshold detector 1420 to a predetermined threshold to determine the detection of a tag. Again, the threshold may alternatively be established based on noise or false alarm rates.

FIG. 16 also shows a data detector 1422 following the in-phase summation 1506A function. The data detector 1422 tests the polarity of the sum value to determine the data state “1” or “0”. Since data polarity depends in part on which RF signal lobe is being received, the data stream, as initially detected may be inverted resulting in a data polarity ambiguity. The data protocol may include periodic transmission of known data to resolve the polarity ambiguity.

An alternative method of resolving the data polarity (not shown) is to utilize multiple codes 1602 and multiple receiver correlation processes (1502, 1506) associated with each code 1602. A first code is selected to represent data “1”. The inverse of the first code also represents data “1”. A Second code substantially orthogonal to the first code is selected to represent data “0”. The inverse of the second code also represents data “0”. The data detection process then assigns the data value in accordance with the detector having the greatest signal value. Thus, a signal and its inverse will result in the same data stream.

FIG. 16 also shows an optional tracking loop 1608. The purpose of the tracking loop is to maintain synchronization between the receiver chip signals and the received chip signal (signal reflected by the tag). In the embodiment shown in FIG. 16, the Q correlation channel generates a tracking error signal. Since the tracking error polarity inverts as the data inverts, a data feedback signal is provided to invert the tracking error signal in accordance with the detected data. The tracking error signal is then filtered and used as feedback 1610 to control the timing system 1404 to advance or retard system timing to maintain synchronization. Alternatively, the timing may be adjusted by inserting or deleting samples in the sample stream 1412, or by adjusting clock cycles in the code signal 1604A and 1604B. Other methods may be implemented for maintaining data synchronization such as a Costas loop, or the periodic transmission of known data which is utilized for tracking.

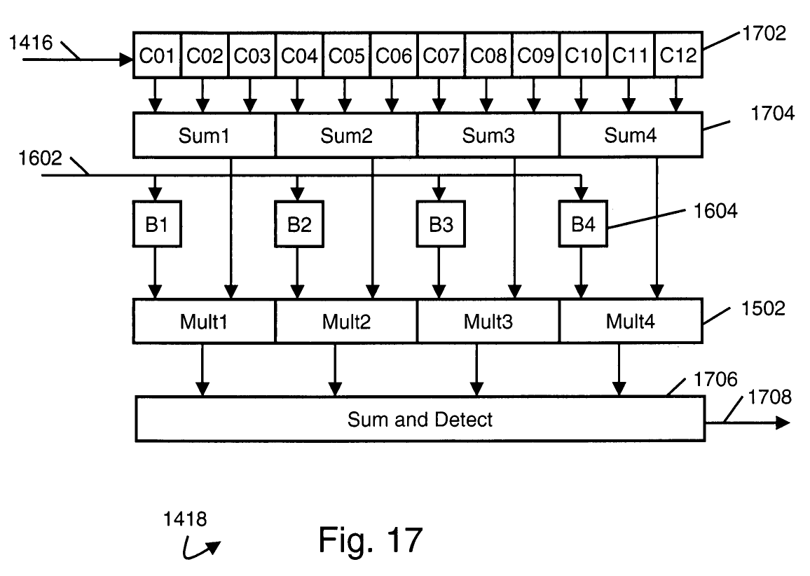

FIG. 17 illustrates an exemplary embodiment of an alternative code matching process 1418 in accordance with the present invention. The code matching process 1418 of FIG. 17 utilizes parallel processing to generate a correlation match between the received signal and the code. The code matching function of FIG. 17 may be used singly as in FIG. 15 or in pairs as in FIG. 16. The received sample stream 1416 may comprise the signal samples from the multiplier 1412 or may comprise the output of the partial-summation step 1414. The partial-summation step 1414 may be included to reduce the complexity and work load of the code matching process 1418. For example, the pulse rate and initial sample rate may be 3 mega samples per second. The partial-summation step 1414 may sum 100 samples, yielding a 30 kilo samples per second output. Thus, the code matching process 1418 needs to sum only three partial summation 1414 output samples to yield a 10 kilo chip per second code compare rate.

Referring to FIG. 17, in a first embodiment, the received sample stream 1416 is clocked into the data register 1702 by shifting the contents of C01 through C11 to the left one position and loading the next sample 1416 into position C01. The summation block 1704 sums samples three at a time and presents the output to the multiply function 1502. A code 1602 is loaded into the code register 1604. The code 1602 preferably comprises values +1 and −1. The multiply function 1502 multiplies each sum 1704 by the associated code value 1604 and the results are presented to the sum and detect block 1706 where the results are summed and compared with a threshold to produce a detection (as in FIG. 15 sum 1506 and detect 1508). If a signal presence detection 1708 is desired, the summed result is compared with a predetermined threshold as with FIG. 16 detection. If data is to be detected, the summed results are compared with zero to determine the polarity to produce a data bit detection 1708.

In a second embodiment, the data register 1702 is filled with twelve new data samples before the summation process 1704 is performed. The second embodiment is preferably utilized to detect data once synchronization has been established between the tag and the receiver. The first embodiment is preferably utilized to initially detect a tag before synchronization has been established. Although the registers are shown a particular length in the exemplary embodiment of FIG. 17, the registers may be designed for any appropriate length for a given application.

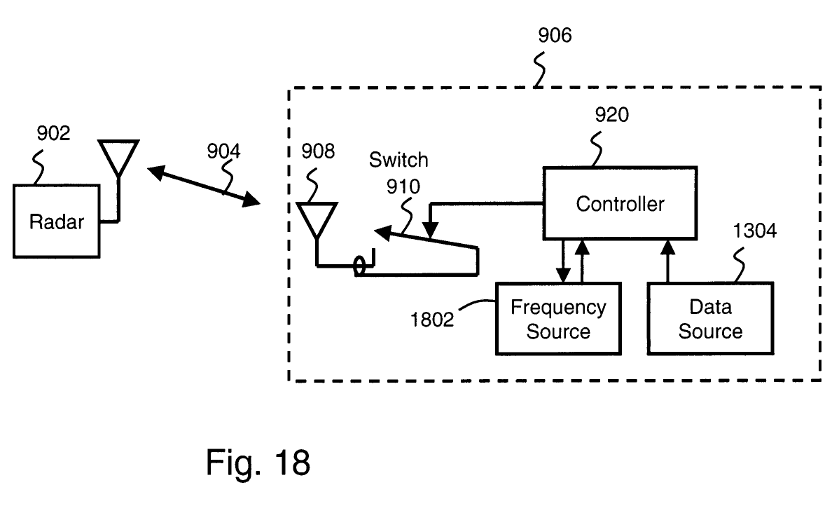

FIG. 18 illustrates a tag system based on frequency modulation. In the system of FIG. 18, the data 1304 is used to control a frequency source 1802 according to a predetermined frequency modulation plan established by the controller 920. In one embodiment, two frequencies are selected 1802 based on the data value 1304. One frequency is selected for data “1” and the other is selected for data “0.” Each data state is held constant in frequency for one or more chip times (a chip time may comprise an on-off switch cycle). For example, in a system utilizing chip rates of 10 kcps and 11 kcps (chips per second), a data “1” may be represented by ten cycles of a 10 kHz square wave. Each positive state of the square wave opens the switch and each negative state closes the switch. Likewise a data “0” may be represented by eleven cycles of a 11 kHz square wave. Again, each positive state of the square wave opens the switch and each negative state closes the switch. Thus data is conveyed at a 1 kilo bit per second rate.

Referring to FIG. 18, the controller 920 receives data from a data source 1304. The controller 920 then controls a frequency source 1802 in accordance with the data value and a modulation protocol. The frequency source 1802 supplies the commanded frequency and the controller 920 controls the switch 910 in accordance with the supplied frequency. The radar 902 sends a pulse 904 toward the tag antenna 908. The pulse 904 is received by the antenna 908 and coupled to the switch 910. Depending on the state of the switch, the pulse is reflected in phase or inverted and transmitted again by the antenna 908. The reflected pulse is received by the radar 902.

The radar 902 typically sends a number of pulses 904 over a time interval to the tag 906 and receives a number of reflected pulses from the tag 906. The sequence of reflected pulses is then analyzed to determine the presence of a switching frequency associated with the tag 906. The switching frequency may comprise a set of frequencies utilized to convey data 1304.

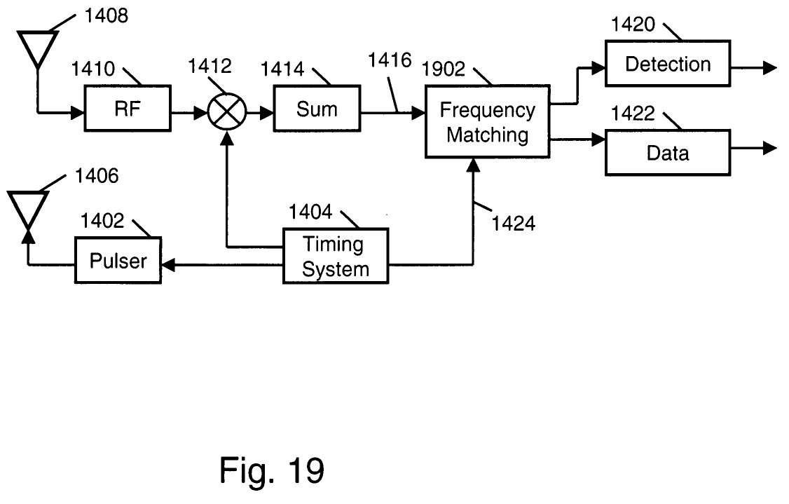

FIG. 19 illustrates an exemplary radar probing system adapted to detect a tag wherein the tag is frequency modulated. The system of FIG. 19 is similar to the system of FIG. 14 except for the utilization of a frequency detector 1902 in place of the code detector (FIG. 14, code matching 1418). In one embodiment, the frequency detector 1902 comprises a fast Fourier process. In another embodiment, the frequency detector 1902 comprises one or more filters. In one embodiment, the filter, or FFT output for a selected frequency is compared with a predetermined level. In another embodiment, the selected frequency output is compared with a signal indicating the background noise level. A background noise level may be derived from FFT outputs or filter outputs that do not include the tag switching frequency (FIG. 18, 1802). For example, if the tag is switching between 10 kHz and 11 kHz, a background noise signal may be derived by measuring a 9 kHz output or a 12 kHz output or both. A tag presence detection may be triggered by the 10 kHz or the 12 kHz signal exceeding some multiple of the noise level detected from the 9 kHz output (for example five times the noise level).

Tag data 1304 may be detected 1422 by comparing the 10 kHz signal level and the 11 kHz signal level, the detected data state 1422 being assigned in accordance with the greater level.

Tag Embodiments

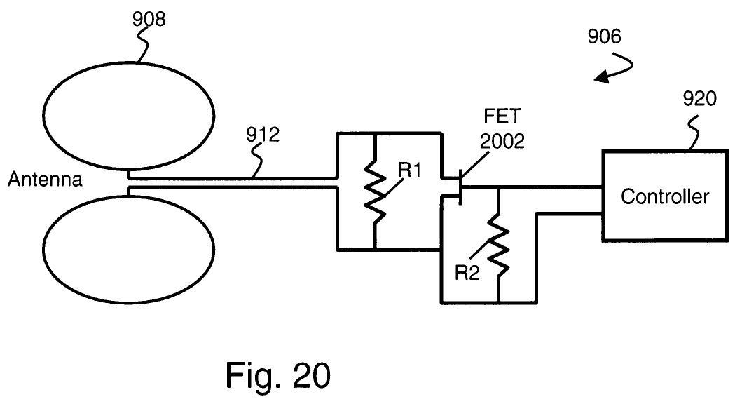

FIG. 20 is a schematic diagram of a reflective tag utilizing a FET switch element. Referring to FIG. 20, a controller 920 drives the gate of a microwave Field Effect Transistor (FET) 2002 to alternately bias the FET 2002 to a high impedance state and a low impedance state. The FET 2002 is coupled to an antenna 908 through an optional transmission line 912. In the high impedance state, the FET 2002 is essentially an open circuit with a very small stray capacitance. In the low impedance state, the FET 2002 has an impedance significantly lower than the matching impedance of the antenna 912 and thus appears substantially as a short circuit.

The ellipses 908 depict a planar elliptical dipole antenna 908. A planar elliptical dipole antenna 908 is found to exhibit substantially omnidirectional response and presents a good match over an ultra wide bandwidth. The planar elliptical dipole antenna 908 is highly efficient and performs well as a tag antenna 908. An example of an elliptical dipole antenna including a balun feed may be found in U.S. Pat. No. 6,512,488, issued Jan. 28, 2003 and U.S. patent application Ser. No. 09/670,792, filed Sep. 27, 2000, which are both incorporated herein by reference.

Resistor R1 is optional and may be equal to the antenna 908 or line 912 impedance. When this resistor is equal to the line 912 impedance, then the tag switches between an inverted return and a maximally absorbed signal. There is, however a residual reflection even from a perfectly matched antenna due to edge effects. Resistor R2 is optional and may be part of the bias network.

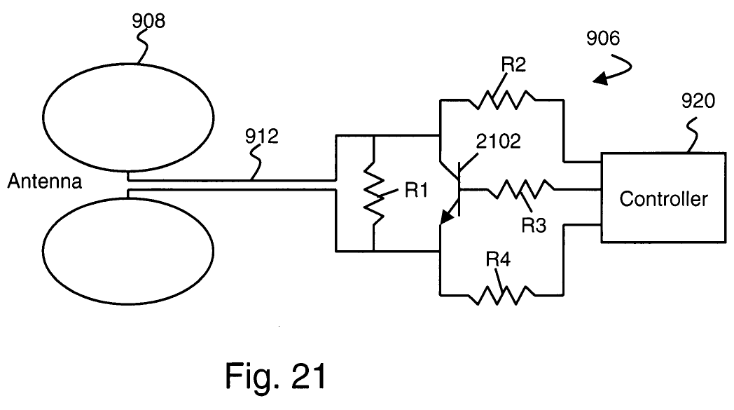

FIG. 21 is a schematic diagram of a reflective tag utilizing a bipolar transistor as a switch element. Referring to FIG. 21, the controller 920 provides bias to turn the transistor 2102 on or off. R2, R3, and R4 represent bias resistors and can also serve as RF decoupling to control the RF energy around the switch. R2, R3, and/or R4 may be accompanied or replaced by inductors or other RF decoupling components. R1 is optional and may be used to provide a matched load when the transistor is in an off state.

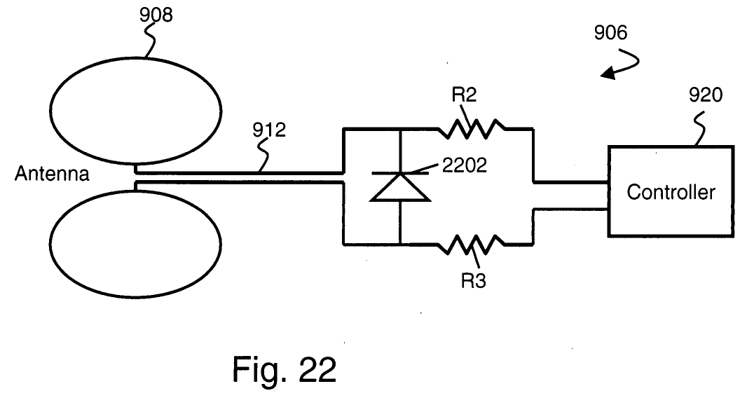

FIG. 22 depicts a reflective tag utilizing a PIN diode as a switch element. Referring to FIG. 22, Diode 2202 is a PIN diode operating as a line termination load resistor. R2 and R3 are bias elements that also may serve as RF decoupling components. PIN diodes operate essentially as variable resistors with the RF conductance being a function of the bias current. Thus, with no bias current, the resistance is highest and corresponds to the open switch condition. With full bias current, the resistance is lowest and corresponds to the closed switch condition. Intermediate bias levels may be used for multi-state digital or analog modulation. The terminating resistor R1 is not shown but may be included as in FIG. 20.

In the circuit of FIG. 22, the diode 2202 may also represent other RF diodes such as a Schottkey diode. Such a diode would be operated with no bias or reverse bias for an “off,” or switch open, state and forward biased for an “on,” or switch closed, state.

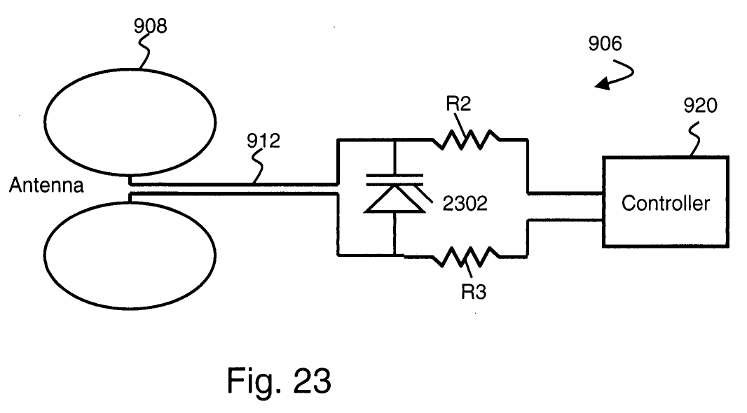

FIG. 23 illustrates one embodiment employing a varactor diode as a switch element. Varactor diodes vary the capacitance as a function of a reverse bias DC voltage applied across the junction. In FIG. 23, varactor diode 2302 acts as a capacitive termination to the antenna 908 or optional transmission line 912. The resistors R2 and R3 provide RF decoupling. A change in the capacitive load on the antenna 908 is utilized to change the reflective properties of the antenna. Preferably, the capacitive reactance varies from a value much greater than the antenna impedance to a value much less than the antenna impedance, for example from a value three times the antenna impedance to a value one third the antenna impedance.

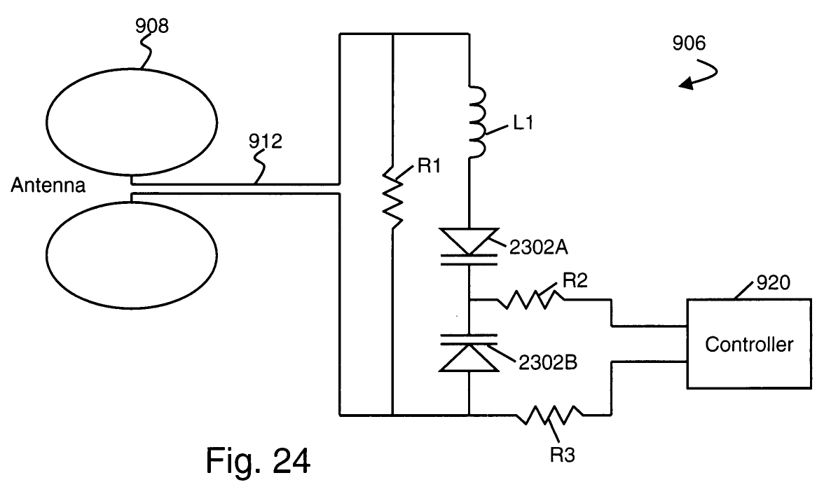

FIG. 24 illustrates an alternative embodiment employing varactor diodes as switch elements. In FIG. 24, two diodes 2302A and 2302B are used in series to lower the capacitance and enable higher frequency operation. The inductor L1 is provided to tune out the capacitance at maximum capacitance for the center frequency. L1 should be selected for series resonance at the center frequency of operation. This will improve the low impedance state to more nearly approximate a short. Resistors R1 and R3 provide a DC return path for the bias and may be replaced by or include an inductor. When R1 is used as a bias return path, it may be a very high value, such as 10 k ohms. When R1 is used as a matching load resistor, it may be on the order of 50 ohms.

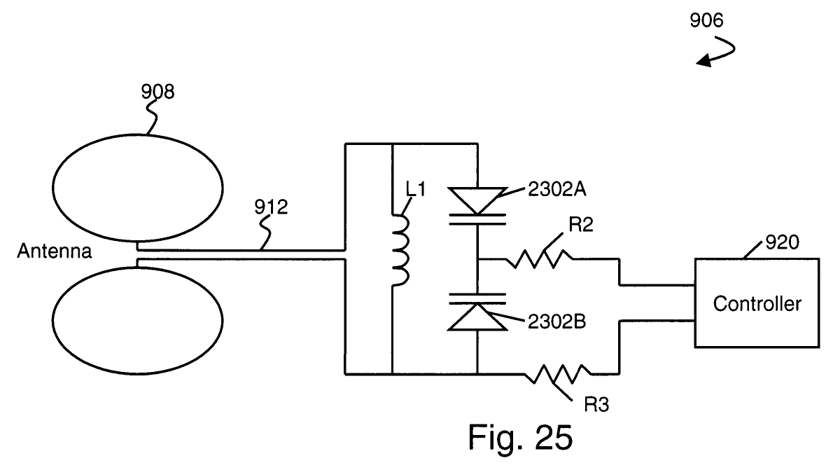

FIG. 25 illustrates a further alternative embodiment employing varactor diodes. In FIG. 25, the inductor L1 is placed in parallel to generate parallel resonance at the mimimum capacitance state to more nearly approximate an open circuit. R1 (not shown) is not needed as a DC bias return path, but may be used as a matching load resistor.

The circuits of FIGS. 23-25 may be designed such that the load presented to the antenna 908 is a reactance equal to the antenna impedance at the center frequency. The reactance may be capacitive at one bias voltage state and may be the same magnitude, but inductive at a lower DC bias value. In this manner, numerous complex impedance loads may be produced by driving associated bias levels. Thus, for the varactor diode embodiments, multiple levels of DC bias drive may be selected for multi-level digital modulation or analog modulation.

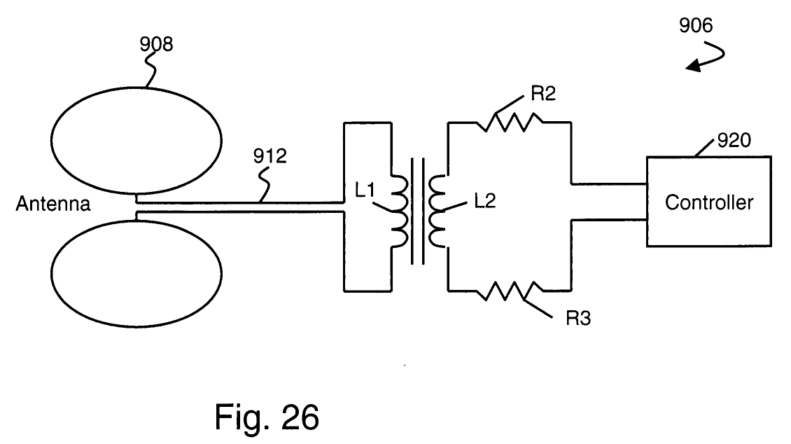

The circuit of FIG. 26 represents a system based on using a saturable reactor as a switch element. In FIG. 26, L1 is a coil coupled to a saturable reactor core. The reactor core is also coupled to L2, which is used to drive a DC saturating current into the reactor core. With no DC current drive, the inductive reactance of L1 is preferably greater than the antenna impedance and when the DC current is maximum, the inductive reactance is preferably less than the antenna impedance. As in the case of the varactor based embodiments, the inductance L1 may be combined with series or parallel capacitance to yield better performance through series or parallel resonance effects. R2 and R3 may be used for bias and for RF decoupling.

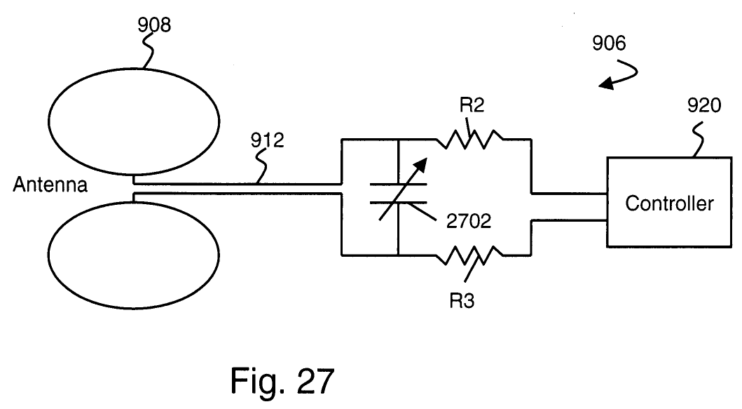

FIG. 27 represents a system based on a variable capacitance element. The variable capacitance element 2702 may be a MEMS (micro electro-mechanical systems) device or a piezoelectric device or other variable capacitance device. A MEMS device could operate by using a high voltage electric field to bend a capacitor plate closer or farther away from another capacitor plate. In a like manner, piezoelectric drive could be used to bend capacitor plates to yield greater or lesser capacitance. As in the case of FIG. 23, the capacitor may be combined with series or parallel inductance to yield better performance through series or parallel resonance effects. In one embodiment, the capacitor 2702 is directly sensitive to acoustics or vibration, producing direct acoustic modulation for a wireless microphone—potentially a batteryless wireless microphone.

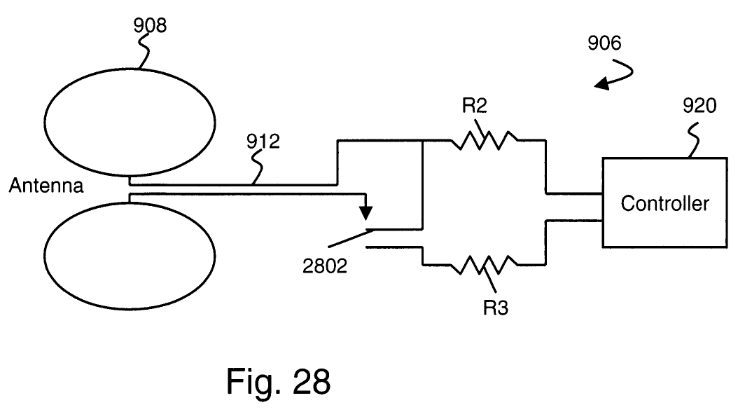

FIG. 28 represents a system based on a MEMS switch. The switch 2802 comprises a fixed element, a flexible element and a contact. A high voltage drive is applied across the fixed and flexible elements to bend the flexible element away from (or could alternatively be configured to bend the flexible element toward) the contact. With no drive voltage, the flexible element is touching the contact and the switch 2802 presents a low impedance, or shorted load to the antenna. Upon application of a high voltage drive, the flexible element is pulled away from the contact and the switch 2802 presents a high impedance or open load to the antenna.

General Considerations for Tag Embodiments

A number of the features shown in one embodiment may be adapted to the other embodiments. Such features include the optional transmission line, the load resistor R1, the series and parallel resonance tuning, and the variable drive levels. In the embodiments shown, the active switch element may be mounted directly on the antenna feed point or may be coupled to the antenna through a transmission line. The antenna or line may be terminated in a series or parallel load resistor. A parallel matched load resistor converts the open switch state to a matched state. A series matched load resistor converts the closed switch state to a matched state. The matched state of the tag provides minimum reflection, but typically provides slight reflection. Most of the embodiments lend themselves to resistive load states between open and short that can be used for complex multistate modulation or analog modulation. Further, the antenna may be coupled to the switch using a transformer or other RF coupling device.

The exemplary embodiments shown represent several of the switch elements possible for use in the present invention. Using these examples as guidance, one skilled in the art may adapt other switch elements for use in the present invention.

Polarization

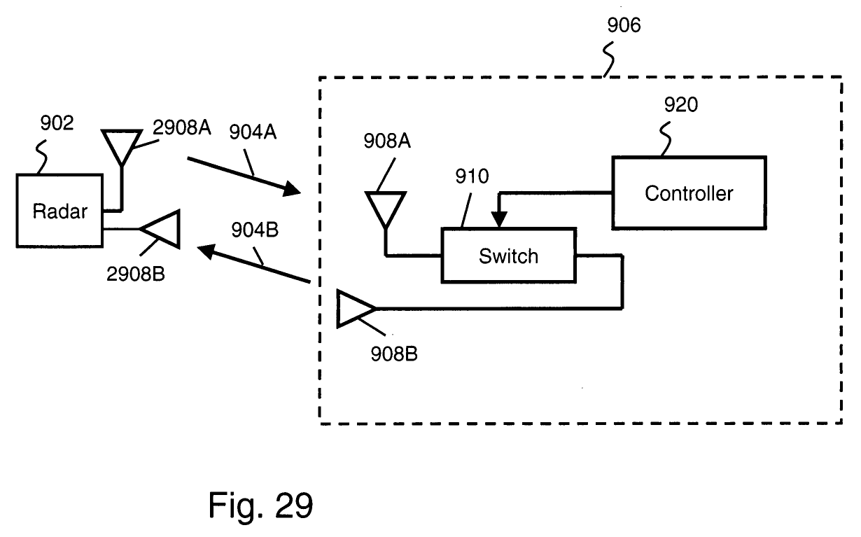

FIG. 29 illustrates a reflective tag utilizing cross polarization. Referring to FIG. 29, the radar 902 transmits pulses 904A vertically polarized using a vertically polarized antenna 2908A. The tag receives pulses using a vertically polarized antenna 908A. A controller 920 controls a switch 910 to alternately couple the vertically polarized antenna 908A to a horizontal polarized antenna 908B. (Or alternatively, switches the polarity of the coupling from the vertically polarized antenna 908A to the horizontally polarized antenna 908B.) The radar 902 receiver is coupled to a horizontally polarized antenna 2908B to receive the horizontally polarized return pulses 904B.

The reflective tag system 900 may also be based on circular polarization (not shown). Using two cross polarized antennas at the tag, one or both may be open or short to produce the desired polarized reflection. Further details on UWB circular polarization may be found in U.S. patent application titled: “System and Method for Duplex Operation Using a Hybrid Element,” Ser. No. 10/971,383, filed Oct. 22, 2004 which is incorporated herein by reference.

Dual Mode Tag

One embodiment of the present invention combines UWB tag sensing with narrow band tag sensing (dual mode sensing). Dual mode sensing may allow greater range by allowing the narrow band radar to probe with much higher power. UWB is typically limited in power by regulatory agencies to allow shared spectrum use. Narrow band signals, however may utilize bands where very high power is available. The narrow band probe, however cannot easily locate the tag. Thus, when a tag is identified by the narrow band probe, the UWB probe radar may be operated to scan for the tag to locate the tag. Further, the narrow band probe may identify multiple tags and the UWB system can then be used to locate the tags and separate the tag signals by range gating.

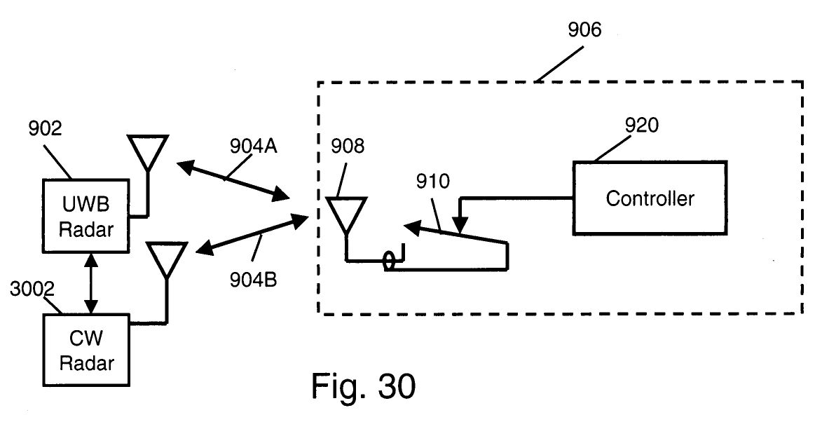

FIG. 30 illustrates a dual mode tag system in accordance with the present invention. The system of FIG. 30 comprises a UWB radar 902, a narrow band radar 3002 and a tag 906.

In one embodiment, the narrow band radar probe 3002 identifies a tag 906 and decodes the modulation. The narrow band radar 3002 then provides modulation synchronization information to the UWB radar 902 to speed the search for the tag 906 because the UWB radar 902 will not have to search code phase or modulation phase to find the tag 906. The UWB radar 902 can scan the range dimension with knowledge of the modulation phase. If the narrow band radar 3002 is a Doppler radar, the narrow band radar 3002 may also determine the velocity of the tag 906 and may convey velocity information to the UWB radar 902 to further aid in location of the tag 906.

The tag 906 itself may be designed to cover a frequency range including both the UWB and narrow band signals unless the bands are substantially separated. For example if the UWB radar 902 operates from 3 GHz to 6 GHz and the narrow band radar 3002 operates at 5.5 GHz, the UWB tag 906 will need no modification for dual mode operation. If, however, the narrow band radar 3002 is at 10 GHz, care must be taken to insure that the RF tag 906 components can accommodate the 10 GHz RF. Alternatively a separate antenna 908 and RF switch 910 may be included in the tag 906 for the narrow band signal.

Variable Delay Tag

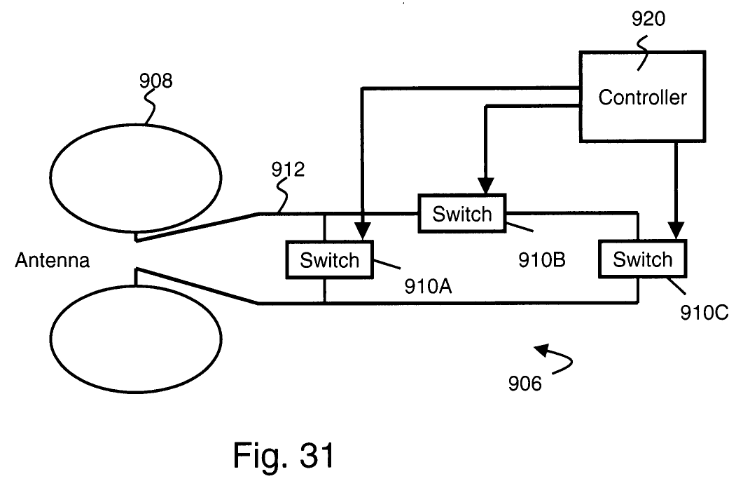

FIG. 31 illustrates one embodiment of a tag utilizing a plurality of switches at different delay times. In FIG. 31, multiple switches are placed along a transmission line, either in parallel or series or both to generate a response comprising pulses at different delay times. The arrangement may be used to generate a response that is pulse position modulated and/or includes a pulse position code. Referring to FIG. 31, the antenna 908 receives a pulse and couples the pulse to a transmission line 912. The transmission line is coupled to three switches 910A, 910B, 910C. Switches 910A and 910B are in parallel with the transmission line. Switch 910B is in series with the transmission line. The controller controls each switch independently in accordance with a modulation protocol. When switch 910A is closed, the pulse is reflected, inverted in phase, at the switch 910A location. When switch 910A is open, the received pulse is passed to switch 910B. When switch 910B is open, the pulse is reflected, in phase, at the switch 910B location. When switch 910B is closed the pulse is passed to switch 910C. When switch 910C is open, the pulse is reflected in phase at the switch 910C location. When switch 910C is closed, the pulse is reflected at the switch 910C location, but inverted in phase.

Each switch location may be placed along the transmission line to produce a response at the desired delay. Delays on the order of a quarter wave at the pulse center frequency may be used for in-phase and quadrature type modulation. Delays longer than a pulse length, may be used for other types of pulse position modulation.

By arranging series and parallel switches, and possibly including matched load resistors or other components, or by using multiple transmission line trees, a wide range of pulse delay architectures may be generated.

FIG. 31 may be modified to illustrate one embodiment comprising a single switch. In the modified embodiment, switch 910A is as shown in FIG. 31. Switch 910B is removed and replaced by a connection bridging the RF terminals. Switch 910C is removed and replaced with a short. Thus, when switch 910A is closed the received pulse is reflected at the Switch 910A location. When switch 910A is open, the received pulse is reflected at the prior Switch 910C location (now shorted).

Power Sources

Because the tag potentially requires such low power, it may be powered from a watch battery, or from a solar cell, or from body chemistry or other very low power sources. The solar cell may be used with a capacitor to store energy during long periods of darkness. The solar cell may even provide enough energy with normal room lighting. The FET and varactor diode embodiments are well suited to micro-power applications.

Alternatively inductively coupled or RF energy may power the device or may charge a capacitor to power the device for extended periods. The device may be physically plugged into a power source to charge a capacitor for extended periods.

Applications

The uses for the tag are numerous including, but not limited to:

Security tag, such as automatic door lock for a car, home, or business, automatic employee entry and exit monitoring system;

Automatic password entry for a computer, either at power up, or screen saver;

Wireless telephone. Wireless microphone;

Wireless mouse, wireless keyboard;

Remote thermometer, remote thermostat, remote wireless door and window entry security sensors;

Inventory tags, Asset tags, retail theft detection tag;

Airline bag tags;

Wireless patient monitoring telemetry;

Car license plate data, status data, automatic toll booth;

Highway feature markers, automated highway markers, centerline markers, stop light markers, collision avoidance devices;

Materials sensing;

Float level sensing;

Position sensing;

Appliance status, diagnostic information;

Pet locator, pet door activator;

Remote meter reading (such as water meter or electric meter)

Livestock tag (ear tag), automatic feeder activator, livestock ID and record keeping (as in a dairy farm); and

Internal body sensors for medical conditions.

The low power consumption and precision location features of the invention present advantages for numerous other applications as well.

### CONCLUSION

While particular embodiments of the invention have been described, it will be understood, however, that the invention is not limited thereto, since modifications may be made by those skilled in the art, particularly in light of the foregoing teachings. It is, therefore contemplated by the appended claims to cover any such modifications that incorporate those features or those improvements which embody the spirit and scope of the present invention.

What is claimed is:

1. A system for detecting an object, said system comprising:
(1) an ultra wideband transmitter for transmitting an ultra wideband probe signal;
(2) a tag device associated with the object and located proximal to the object, the tag device further comprising:
an antenna for receiving the ultra wideband probe signal;
a switch coupled to the antenna, said switch for modulating the probe signal received by the antenna and reflecting a portion of said signal back to the antenna; and
a controller coupled to the switch, said controller causing the switch to modulate the reflected signal in accordance with a time sequence pattern; and
(3) an ultra wideband receiver for receiving the modulated reflected signal and identifying the time sequence pattern.

2. The system of claim 1, wherein the transmitter is an impulse transmitter.

3. The system of claim 1, wherein the antenna is an elliptical dipole.

4. The system of claim 1, wherein the switch is one of the group: a FET, a bipolar transistor, a PIN diode, a varactor diode, a variable capacitor, and a MEMS switch.

5. The system of claim 1, wherein the time sequence pattern includes a code pattern.

6. The system of claim 1, wherein the time sequence pattern includes a frequency modulated pattern.

7. The system of claim 1, wherein the modulation of the reflected signal is pulse position modulation.

8. The system of claim 1, further including a transmission line and a plurality of switches, each switch at a different delay along the transmission line, each said switch controlled in accordance with a protocol; wherein the reflected signal is modulated with pulse position modulation.

9. The system of claim 1, wherein data is encoded on the time sequence pattern.

10. The system of claim 1, further including a plurality of objects, each of said objects having a tag device associated with said object; wherein the modulated reflected signal from a first object is distinguished from the modulated reflected signal from a second object by range gating the modulated reflected signal from the first object.

11. A method for detecting an object comprising:
transmitting an ultra wideband signal toward an antenna;
modulating the impedance of a load connected to the antenna; and
receiving a reflected ultra wideband signal, said reflected ultra wideband signal being reflected from the load and having modulation resulting from the modulation of the impedance of the load; and
detecting the modulation of the reflected ultra wideband signal.

12. The method of claim 11, further comprising the step of:
determining the radar range to the antenna.

13. The method of claim 11, wherein the impedance is modulated in accordance with data; the method further comprising the step of:
determining the data from the modulation.

14. The method of claim 13, wherein the modulation includes a code pattern.

15. The method of claim 14, wherein the code is one of a PN code, a Barker code, a Kassami code, and a Gold code.

16. The method of claim 13, wherein the modulation includes a frequency modulated signal.

17. The method of claim 13, wherein the modulation is analog modulation.

18. The method of claim 13, wherein the modulation is pulse position modulation.

19. The method of claim 13, wherein the detecting is performed by a dual channel IQ detector.

20. The method of claim 13, wherein the load is varied by one of a FET, a bipolar transistor, a PIN diode, a varactor diode, a variable capacitor, and a MEMS switch.
